(19) United States
(12) Patent Application Publication
(10) Pub. No.: US 2018/0331930 A1
(43) Pub. Date: Nov. 15, 2018

(54) NON-TRANSITORY COMPUTER-READABLE RECORDING MEDIUM RECORDING BURST DETECTION PROGRAM, BURST DETECTION METHOD AND INFORMATION PROCESSING APPARATUS

(71) Applicant: FUJITSU LIMITED, Kawasaki-shi (JP)

(72) Inventor: Chunghan Lee, Yokohama (JP)

(73) Assignee: FUJITSU LIMITED, Kawasaki-shi (JP)

(21) Appl. No.: 15/967,637

(22) Filed: May 1, 2018

(30) Foreign Application Priority Data
May 10, 2017 (JP) 2017-093931

(51) Int. Cl. H04L 12/26; H04L 12/931; H04L 12/933; H04L 12/24; H04L 12/841

(52) U.S. Cl. CPC H04L 43/0876; H04L 49/70; H04L 47/28; H04L 43/0852; H04L 41/20; H04L 49/15

(57) ABSTRACT

A non-transitory computer-readable recording medium having stored therein a program for causing a computer to execute a burst detection process, the burst detection process includes: setting a virtual switch to notify passage information indicating a passage of a segment of a specific flow when the segment of the specific flow passes through the virtual switch; recording notification time of the passage information in a storage when the passage information is notified from the virtual switch; and determining whether a burst occurs in the virtual switch, based on the notification time of the passage information recorded in the storage.

### CROSS-REFERENCE TO RELATED APPLICATION

This application is based upon and claims the benefit of priority of the prior Japanese Patent Application No. 2017-093931, filed on May 10, 2017, the entire contents of which is incorporated herein by reference.

### FIELD

The embodiments discussed herein are related to a non-transitory computer-readable recording medium recording a burst detection program, a burst detection method and an information processing apparatus.

### BACKGROUND

In the software defined network (SDN) environment, a virtual network is constructed with a plurality of multi-stage virtual switches (so-called a SDN pipeline). A virtual port of a virtual switch may add a queue and collect packets. Meanwhile, due to a load of calculation resources of a server or a process load of each virtual switch in the SDN pipeline, the packets accumulated in the virtual port may be discharged instantaneously, and as a result, a burst may occur.

Related technologies are disclosed in, for example, Japanese Laid-Open Patent Publication No. 2013-197643.

### SUMMARY

According to one aspect of the embodiments, A non-transitory computer-readable recording medium having stored therein a program for causing a computer to execute a burst detection process, the burst detection process includes: setting a virtual switch to notify passage information indicating a passage of a segment of a specific flow when the segment of the specific flow passes through the virtual switch; recording notification time of the passage information in a storage when the passage information is notified from the virtual switch; and determining whether a burst occurs in the virtual switch, based on the notification time of the passage information recorded in the storage.

The object and advantages of the disclosure will be realized and attained by means of the elements and combinations particularly pointed out in the claims. It is to be understood that both the foregoing general description and the following detailed description are exemplary and explanatory and are not restrictive of the disclosure, as claimed.

### BRIEF DESCRIPTION OF DRAWINGS

FIG. 1 is an explanatory view illustrating an example of an information processing apparatus according to an embodiment;

FIG. 2 is an explanatory view illustrating an example of an SDN pipeline;

FIG. 3 is an explanatory view illustrating an example of an occurrence of a burst;

FIG. 4 is a block diagram illustrating an example of a hardware configuration of the information processing apparatus;

FIG. 5 is an explanatory view illustrating an example of stored contents of a flow table;

FIG. 6 is an explanatory view illustrating an example of stored contents of a monitoring table;

FIG. 7 is a block diagram illustrating an example of a functional configuration of the information processing apparatus;

FIG. 8 is a block diagram illustrating an example of a functional configuration of a flow determination unit;

FIG. 9 is a block diagram illustrating an example of a functional configuration of a burst monitoring unit;

FIG. 10 is an explanatory view illustrating an example of a data structure of an action message AM;

FIG. 11 is an explanatory view illustrating an example of a data structure of an event message IM;

FIG. 12 is a block diagram illustrating an example of a functional configuration of a burst detection unit;

FIG. 13 is an explanatory view illustrating an example of a data structure of a period message DM;

FIG. 14 is an explanatory view illustrating an example of a data structure of a burst message BM;

FIG. 15 is an explanatory view illustrating an example of a time interval at which a segment of a specific flow passes through each of virtual switches SW1 to SW3 (burst at “out” of SW2);

FIG. 16 is an explanatory view illustrating an example of an operation of the information processing apparatus (burst at “out” of SW2);

FIG. 17 is an explanatory view illustrating an example of a time interval at which a segment of a specific flow passes through each of virtual switches SW1 to SW3 (burst at “in” of SW2);

FIG. 18 is an explanatory view illustrating an example of an operation of the information processing apparatus (burst at “in” of SW2);

FIG. 19 is an explanatory view illustrating an example of a time interval at which a segment of a specific flow passes through each of virtual switches SW1 to SW3 (not burst);

FIG. 20 is an explanatory view illustrating an example of an operation of the information processing apparatus (no burst);

FIG. 21 is a flowchart (part 1) illustrating an example of a procedure of a flow determination process by the information processing apparatus;

FIG. 22 is a flowchart (part 2) illustrating an example of a procedure of a flow determination process by the information processing apparatus;

FIG. 23 is a flowchart illustrating an example of a procedure of a burst monitoring process by the information processing apparatus; and

FIG. 24 is a flowchart illustrating an example of a procedure of a burst detection process by the information processing apparatus.

### DESCRIPTION OF EMBODIMENTS

For example, a latency measurement is performed along a passing route of a user packet at all times in a communication apparatus, and a measurement latency value and a latency threshold value are compared with each other. When the measurement latency value exceeds the latency threshold value, a target user packet bandwidth is increased, and a warning is sent to a network administrator.

For example, a load may occur in the detection of a burst occurring in the virtual network, and thus, may cause an increase in the number of the calculation resources used for the detection of a burst.

For example, the load occurring in the burst detection may be suppressed.

Hereinafter, embodiments of a burst detection method and an information processing apparatus according to the present disclosure will be described in detail with reference to the accompanying drawings.

### EMBODIMENTS

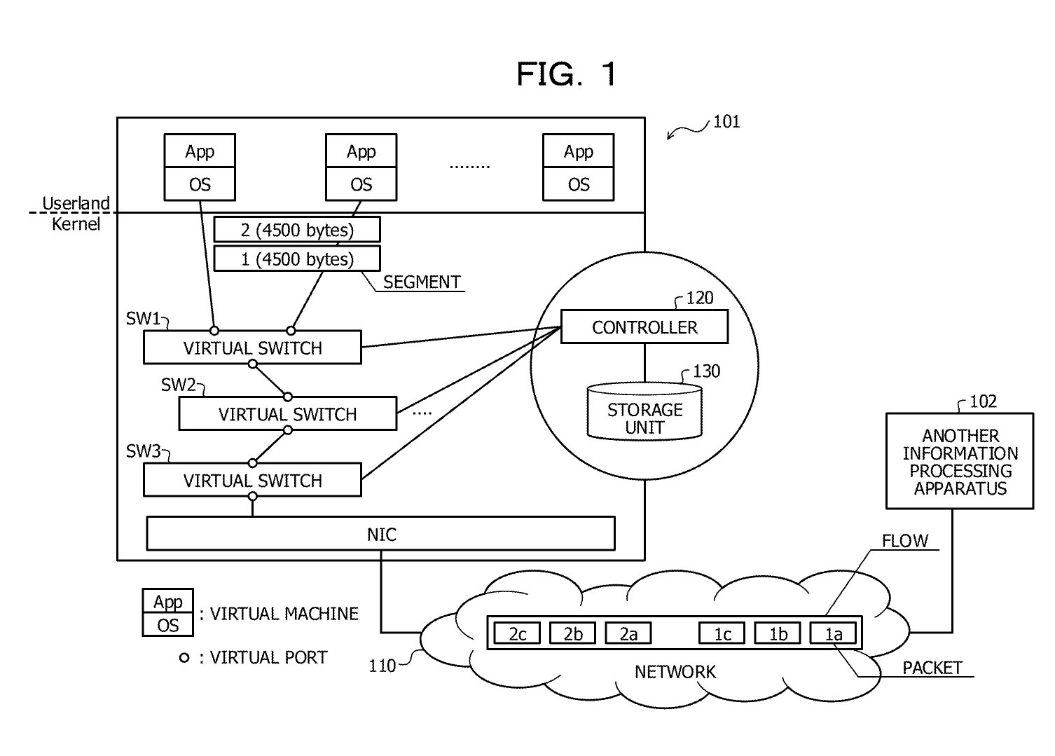

FIG. 1 is an explanatory view illustrating an example of an information processing apparatus 101 according to an embodiment. In FIG. 1, the information processing apparatus 101 is a computer capable of executing a plurality of different operating systems (OSs) by virtualizing hardware resources of the own information processing apparatus 101. The hardware resources of the own apparatus are, for example, a central processing unit (CPU), a memory, and an interface (I/F).

For example, the information processing apparatus 101 is capable of activating the OS by a virtual machine (VM) operating in an execution environment constructed by dividing the hardware resources of the own information processing apparatus 101. The virtual machine is a virtual computer operating in the execution environment constructed by dividing the hardware resources of a physical computer.

In addition, the information processing apparatus 101 includes a plurality of virtual switches and may construct a virtual network. The virtual network is a network constructed by software, and couples physical machines or virtual machines to each other. A virtual switch is a virtual network switch having a function of relaying a communication, and couples virtual machines to each other on a physical machine (e.g., the information processing apparatus 101) or couples a virtual machine and an external network to each other.

The virtual switches exist in the kernel of the information processing apparatus 101, and are used to connect virtual machines, containers of namespaces or the like to each other. Each virtual switch includes a virtual port and a virtual bridge. The virtual port is coupled to a virtual machine or another virtual switch, and is responsible for a connection between a virtual machine and a virtual switch or between virtual switches. The virtual port may add queues and collect packets.

In the information processing apparatus 101, when data enters the kernel from a virtual machine (e.g., an application operating on a virtual machine), the data enters in a data unit called a “segment.” The segment is a mass of a plurality of packets. For example, when the size of the segment is “4500 [bytes]” and the size of one packet is “1500 [bytes],” the segment corresponds to three packets. In order to improve the processing performance, a process is executed in the segment unit in the kernel (e.g., each virtual switch). However, the segment is transmitted/received in a state of being divided into packets, for example, between virtual switches or between a virtual switch and a network interface card (NIC).

In addition, in a network 110, a mass of data called a “flow” is transmitted and received. The flow is a mass of packets based on communication information such as an Internet protocol (IP) address, a port number, and a protocol. The network 110 is a wired or wireless network coupling the information processing apparatus 101 and another information processing apparatus 102 to each other. The network 110 includes, for example, a local area network (LAN), a wide area network (WAN), the Internet and the like. The information processing apparatus 101 and another information processing apparatus 102 may be, for example, servers or general computers such as personal computers (PCs). The another information processing apparatus 102 may have substantially the same function as that of the information processing apparatus 101.

Here, the information processing apparatus 101 implements the virtual network by allocating various network functions to the plurality of virtual switches. For example, the information processing apparatus 101 constructs the virtual network with a plurality of multi-stage virtual switches. The plurality of multi-stage virtual switches may be referred to as the “SDN pipeline.”

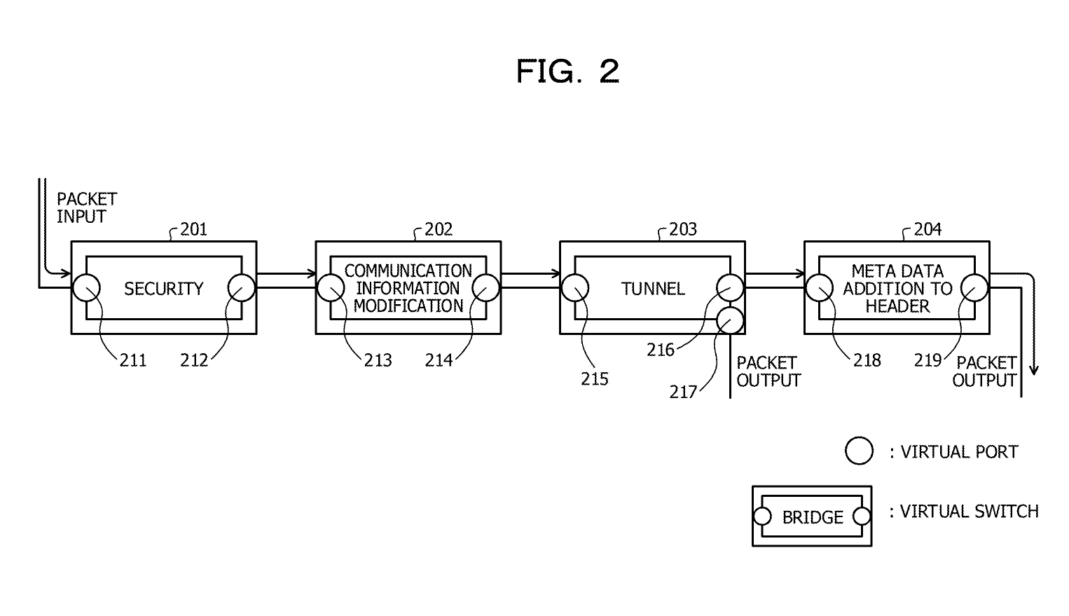

FIG. 2 is an explanatory view illustrating an example of the SDN pipeline. In FIG. 2, the SDN pipeline is formed by virtual switches 201 to 204 which implement respective network functions which are different from each other. The virtual switch 201 includes virtual ports 211 and 212, and performs a process related to security.

The virtual switch 202 includes virtual ports 213 and 214, and performs a process for modifying communication information. The virtual switch 203 includes virtual ports 215 to 217, and performs a process related to tunneling. The virtual switch 204 includes virtual ports 218 and 219, and performs a process for adding metadata to the header.

Here, due to a load of the calculation resources of the physical machine (e.g., the information processing apparatus 101) or a process load of each virtual switch (e.g., each of the virtual switches 201 to 204) in the SDN pipeline, the packets accumulated in a virtual port may be discharged instantaneously, and thus, a burst may occur.

The burst is a phenomenon that an amount of packet transmission increases abruptly per unit time. For example, it is assumed that the virtual switch 201 performs a matching process between a packet input to the virtual port 211 and a rule so as to exclude a packet that does not match the rule. In this case, the processing of the packets input to the virtual port 211 is overloaded, and many packets are accumulated in the queue of the virtual port 212.

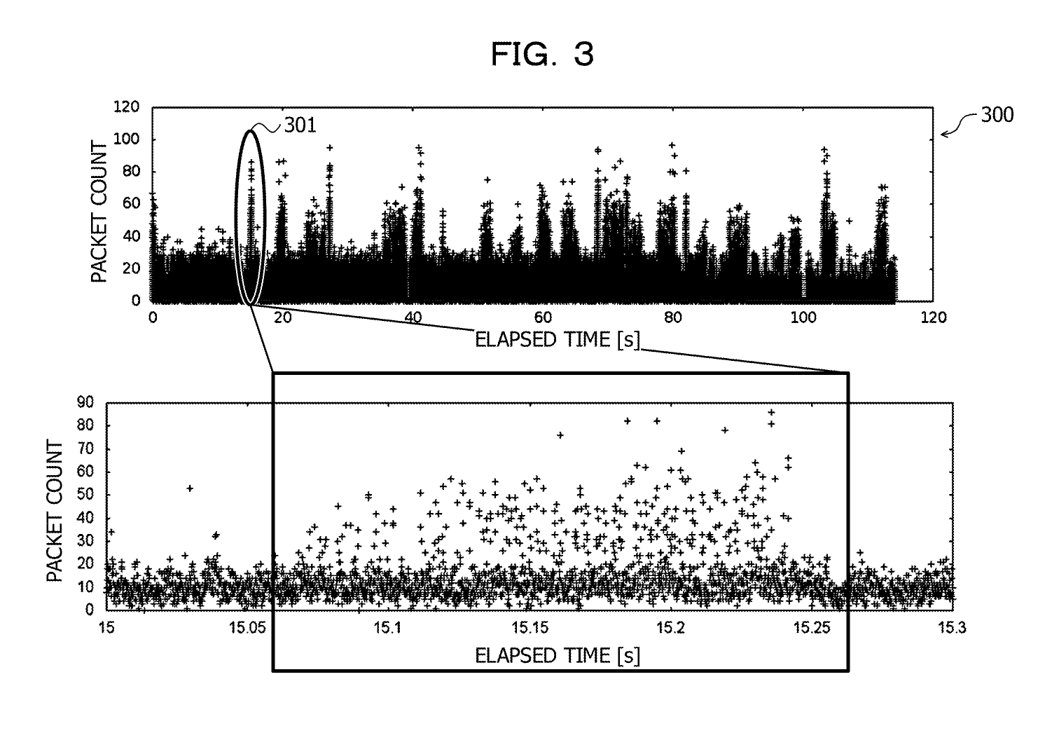

As a result, the packets accumulated in the queue of the virtual port 212 may be discharged instantaneously, and thus, a burst may occur. Here, an example of the occurrence of the burst will be described with reference to FIG. 3.

FIG. 3 is an explanatory view illustrating an example of the occurrence of the burst. In FIG. 3, a graph 300 represents the relationship between the number of packets (vertical axis: Packet count) and elapsed time (Elapsed Time), and also represents bursts occurring in an actual environment. A time interval of a burst is about 200 milliseconds.

For example, in a portion 301, during the burst, the maximum number of packets was approximately 90 packets and the burst duration was 100 microseconds. For example, in the portion 301, the interval of the packets is in the unit of several microseconds, and the packets are discharged instantaneously so that a burst is occurring.

When the burst occurs, the quality of service (QoS) may not be ensured, or packet drop may occur. For example, when the burst occurs in the virtual switch 201, packets may not enter the queue of the virtual port 213 of the subsequent virtual switch 202, and thus, the packet drop may occur. Further, the traffic pattern may be changed due to the burst, and thus, the QoS may not be ensured.

Thus, it is important to detect and cope with a burst occurring in the virtual network. For example, in order to detect a burst, it may be conceived to capture all the virtual ports to collect information (time stamps) of packets, and calculate a difference between time stamps of the respective packets.

However, in order to capture all the virtual ports, a number of CPUs (cores) equivalent to the number of the virtual ports are used. In the example of FIG. 2, nine CPUs (cores) are used to capture the virtual ports 211 to 219. When the number of packets increases, it takes significant time to analyze the packets, and it is difficult to detect a burst in real time.

In addition, it may be conceived to monitor the traffic of packets input to and output from a virtual switch and detect that a burst occurs when an amount of the packets in the virtual switch becomes equal to or more than a threshold value. However, in order to monitor the amount of the packets in each virtual switch within the physical machine, a number of CPUs (cores) equivalent to the number of the virtual ports are used.

In addition, it may be conceived to generate an observation packet, record time stamps when the observation packet passes through each virtual switch, and add each time stamp to the packet. However, in order to generate the observation packet to which the time stamps are added, from the segment, a process of dividing the segment into packet units and adding headers to the packets by using CPU resources is performed. This process causes a load, and thus, many CPU resources are used.

In addition, it may be conceived to add a time stamp to the header in a segment unit. However, in order to add a time stamp at each virtual switch to the header, extra CPU resources are still used, in addition to those for the normal processes. Further, when the number of the virtual switches increases, the number of time stamps to be added increases, and thus, the size of a packet may become larger than the size of a maximum transfer unit (MTU).

Thus, in the present embodiment, descriptions will be made on a burst detection method which suppresses the load caused by the burst detection, by using a segment of a specific flow. In the example of FIG. 1, by using a segment of a specific flow passing through the virtual switches SW1 to SW3, it is determined whether a burst occurs in the virtual switches SW1 to SW3.

For example, a controller 120 of the information processing apparatus 101 sets the virtual switches SW1 to SW3 to notify the information processing apparatus 101 of passage information indicating that the segment of the specific flow passes through the virtual switches SW1 to SW3, when the segment of the specific flow passes through each of the virtual switches SW1 to SW3. As a result, when the segment of the specific flow passes through each of the virtual switches SW1 to SW3, the virtual switches SW1 to SW3 notify the information processing apparatus 101 of the passing information. At this time, each of the virtual switches SW1 to SW3 generates no time stamp.

Next, when the passage information is notified from each of the virtual switches SW1 to SW3, the controller 120 records the notification time of the passage information in a storage unit 130. For example, on a side of the information processing apparatus 101, a time stamp indicating the time when the segment of the specific flow passes through each of the virtual switches SW1 to SW3 is generated. Then, the controller 120 determines whether a burst occurs in each of the virtual switches SW1 to SW3, based on the notification time of the passage information which is stored in the storage unit 130.

Thus, the process load caused by the burst detection is suppressed, and the burst detection may be performed with fewer calculation resources. For example, as compared with a case where all virtual ports are captured, an amount of packets in each virtual switch is monitored, or each virtual switch adds the time stamps, the burst detection may be performed with fewer calculation resources. Hereinafter, an embodiment of the information processing apparatus 101 will be specifically described.

(Example of Hardware Configuration of Information Processing Apparatus 101).

Next, an example of a hardware configuration of the information processing apparatus 101 illustrated in FIG. 1 will be described.

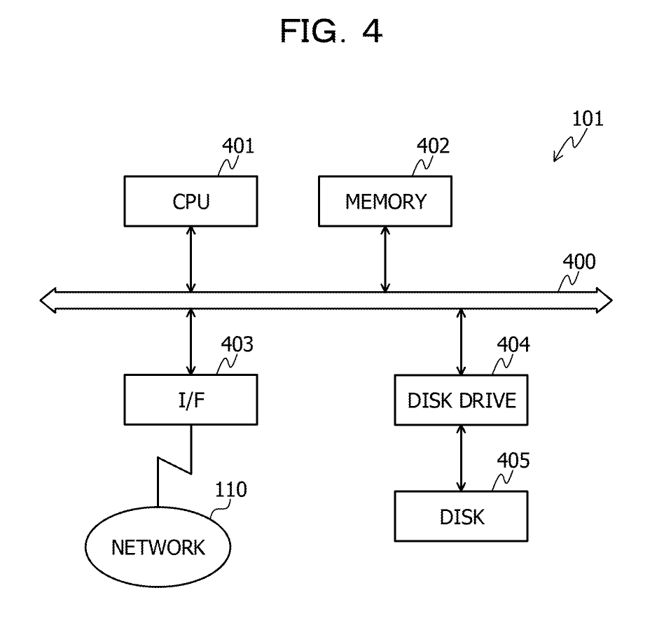

FIG. 4 is a block diagram illustrating an example of a hardware configuration of the information processing apparatus 101. In FIG. 4, the information processing apparatus 101 includes a CPU 401, a memory 402, an I/F 403, a disk drive 404, and a disk 405. Further, the respective components are coupled to each other by a bus 400.

Here, the CPU 401 controls the entire information processing apparatus 101. The CPU 401 may be, for example, a plurality of CPUs or a multi-core processor having a plurality of processor cores. The memory 402 includes, for example, a read only memory (ROM), a random access memory (RAM), a flash ROM and the like. For example, the flash ROM or the ROM stores various programs, and the RAM is used as a work area of the CPU 401. The programs stored in the memory 402 are loaded into the CPU 401, so as to cause the CPU 401 to execute coded processes.

The I/F 403 is coupled to the network 110 via a communication line, so as to be coupled to another apparatus via the network 110. Further, the I/F 403 serves as an interface between the network 110 and the inside of the own apparatus, and controls input/output of data from another apparatus. As for the I/F 403, for example, a modem or an NIC may be adopted.

The disk drive 404 controls reading/writing of data with respect to the disk 405 under the control of the CPU 401. The disk 405 stores the data written under the control of the disk drive 404. As for the disk 405, for example, a magnetic disk, an optical disk or the like may be used.

In addition to the above-described components, the information processing apparatus 101 may include, for example, a solid state drive (SSD), an input device, a display and the like.

(Stored Contents of Flow Table 500)

Next, stored contents of a flow table 500 of the information processing apparatus 101 will be described. The flow table 500 is implemented by, for example, a storage device such as the memory 402 or the disk 405 illustrated in FIG. 4.

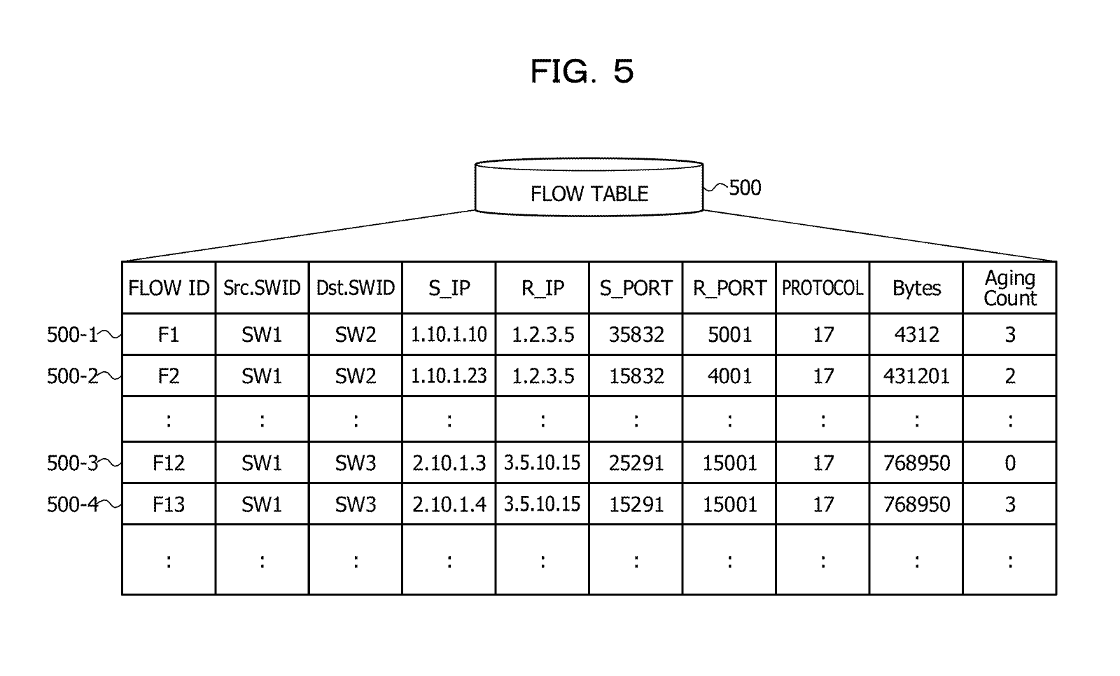

FIG. 5 is an explanatory view illustrating an example of the stored contents of the flow table 500. In FIG. 5, the flow table 500 includes fields of Flow ID, Src.SWID, Dst.SWID, S_IP, R_IP, S_PORT, R_PORT, Protocol, Bytes, and AgingCount. By setting information in each field, flow management information (e.g., flow management information 500-1 to 500-4) is stored as a record.

Here, the Flow ID is an identifier for uniquely identifying a flow. The Src.SWID is an identifier for uniquely identifying a virtual switch of a transmitting side. The Dst.SWID is an identifier for uniquely identifying a virtual switch of a receiving side. The S_IP is an IP address (communication information) of a transmitting-side virtual machine. The R_IP is an IP address (communication information) of a receiving-side virtual machine.

The S_PORT is a port number (communication information) of the transmitting-side virtual machine. The R_PORT is a port number (communication information) of the receiving-side virtual machine. The Protocol is a protocol (communication information) used for a communication between virtual machines. For example, a protocol “17” indicates a user datagram protocol (UDP).

The Bytes is a data transmission amount for a flow of the Flow ID (unit: bytes). The AgingCount is an index value indicating a data transmission status of the flow of the Flow ID. For example, as the AgingCount is small, the data transmission of the flow of the Flow ID is frequently performed.

(Stored Contents of Monitoring Table 600)

Next, stored contents of a monitoring table 600 of the information processing apparatus 101 will be described. The monitoring table 600 is implemented by, for example, a storage device such as the memory 402 or the disk 405 illustrated in FIG. 4. The storage unit 130 illustrated in FIG. 1 corresponds to, for example, the monitoring table 600.

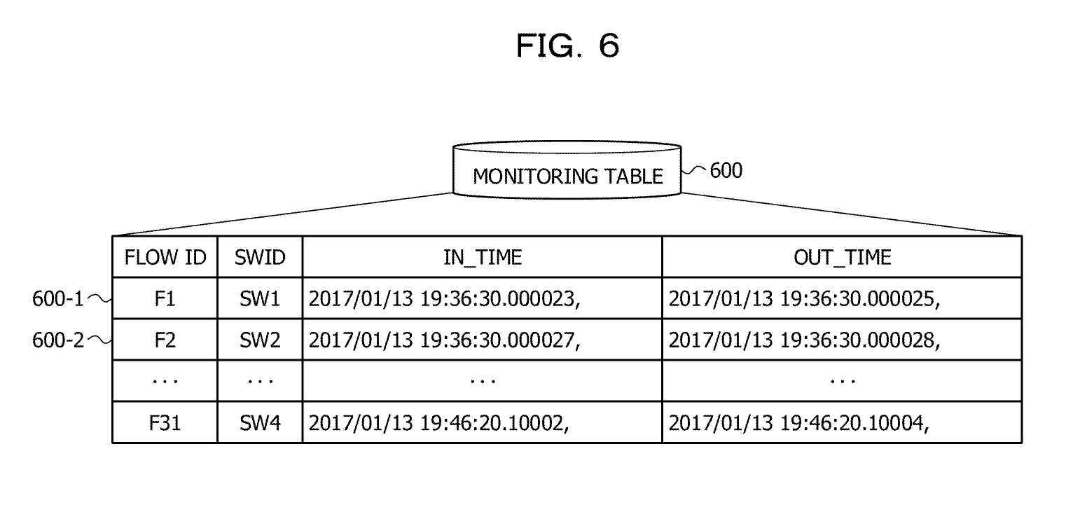

FIG. 6 is an explanatory view illustrating an example of the stored contents of the monitoring table 600. In FIG. 6, the monitoring table 600 has fields of Flow ID, SWID, IN_TIME, and OUT_TIME. By setting information in each field, monitoring information (e.g., monitoring information 600-1 and 600-2) is stored as a record.

The Flow ID is an identifier for uniquely identifying the specific flow. The SWID is an identifier for uniquely identifying a virtual switch through which the segment of the specific flow passes. The IN_TIME is time (date and time up to a microsecond) when the segment of the specific flow is input to a virtual switch. The OUT_TIME is time (date and time up to a microsecond) when the segment of the specific flow is output from a virtual switch.

(Example of Functional Configuration of Information Processing Apparatus 101)

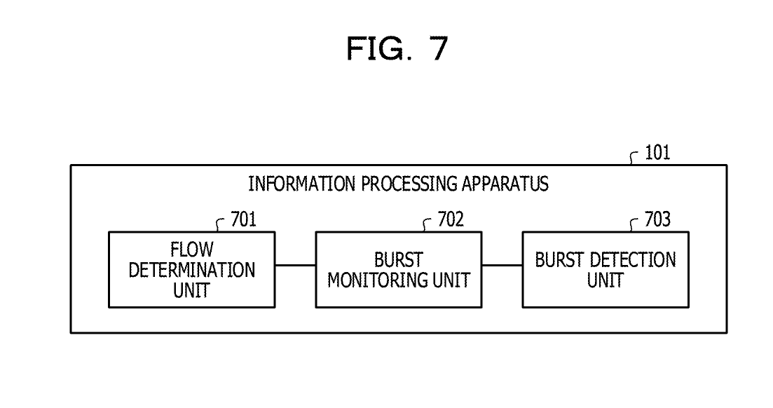

FIG. 7 is a block diagram illustrating an example of a functional configuration of the information processing apparatus 101. In FIG. 7, the information processing apparatus 101 is configured to include a flow determination unit 701, a burst monitoring unit 702, and a burst detection unit 703. The flow determination unit 701, burst monitoring unit 702, and burst detection unit 703 correspond to a function of a controller (e.g., the controller 120 illustrated in FIG. 1). For example, the functions are implemented by causing the CPU 401 to execute the programs stored in, for example, a storage device such as the memory 402 or the disk 405 illustrated in FIG. 4, or implemented by the I/F 403. A process result of each of the functional units is stored in, for example, a storage device such as the memory 402 or the disk 405.

In the descriptions hereinafter, the plurality of virtual switches included in the information processing apparatus 101 may be referred to as “virtual switches SW1 to SWn” (n: a natural number of 2 or more). In addition, among the virtual switches SW1 to SWn, an arbitrary virtual switch may be referred to as a “virtual switch SWi” (i=1, 2, . . . , n).

The flow determination unit 701 determines the specific flow. Here, the specific flow is a flow used to detect a burst occurring in the virtual network, among flows flowing through a path. The path is a path in which data transmission/reception are performed between the transmitting side and the receiving side via physical machines (e.g., the information processing apparatuses 101 and 102) or a network (e.g., the network 110).

For example, the flow determination unit 701 determines the specific flow based on a communication amount or a communication frequency of a flow of which segment passes through the virtual switch SWi forming the virtual network. In addition, the flow determination unit 701 may determine the specific flow corresponding to each path.

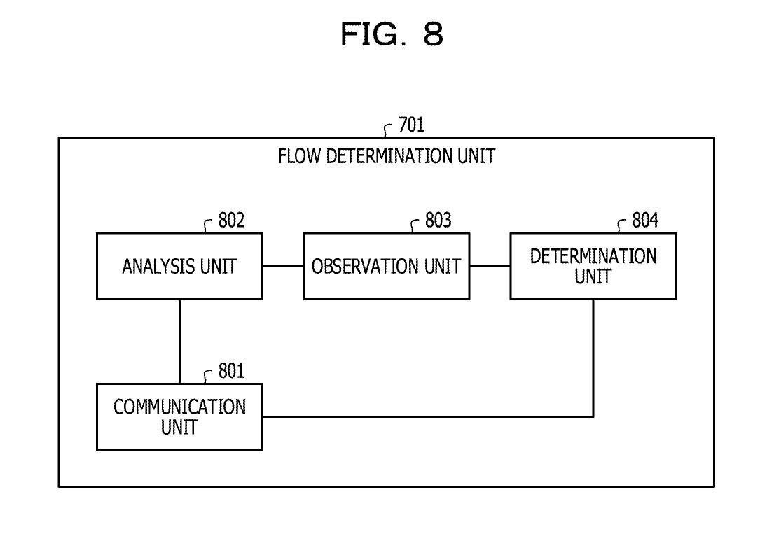

An example of the functional configuration of the flow determination unit 701 will be described later with reference to FIG. 8.

The burst monitoring unit 702 sets the virtual switch SWi forming the virtual network to notify the passage information when the segment of the specific flow passes through the virtual switch SWi. Here, the passage information is information indicating the passage of the segment of the specific flow. Further, when the passage information is notified from the virtual switch SWi, the burst monitoring unit 702 records the notification time of the passage information in a storage device such as the memory 402 or the disk 405.

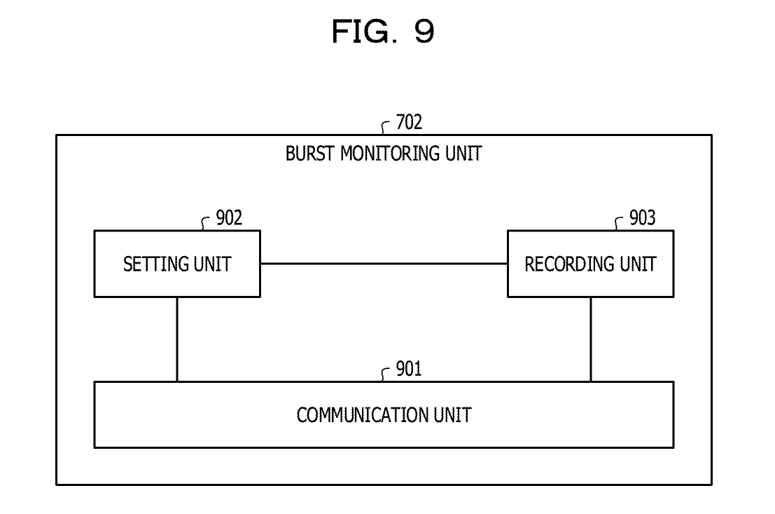

An example of the functional configuration of the burst monitoring unit 702 will be described later with reference to FIG. 9.

The burst detection unit 703 determines whether a burst occurs in the virtual switch SWi, based on the recorded time when the passage information is notified from the recorded virtual switch SWi. For example, the burst detection unit 703 determines whether a burst occurs in the virtual switch SWi, based on, for example, a time interval at which the passage information is notified from the virtual switch SWi.

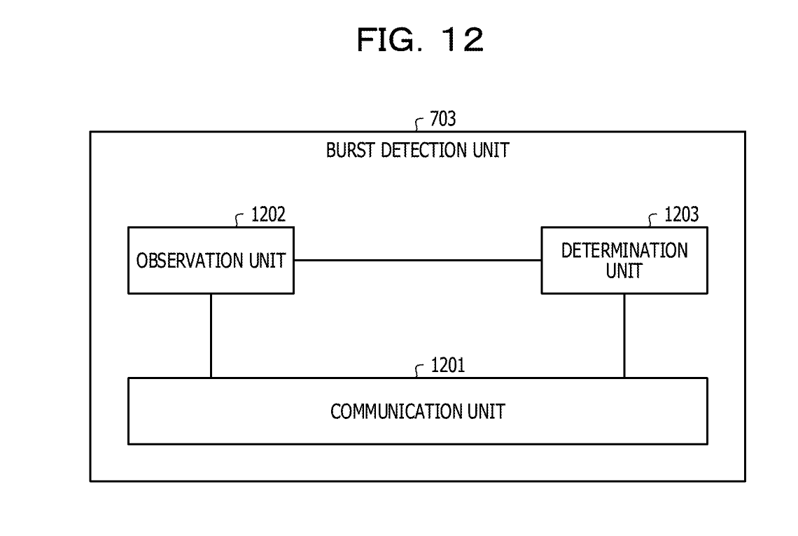

An example of the functional configuration of the burst detection unit 703 will be described later with reference to FIG. 12.

Example of Specific Functional Configuration of Flow Determination Unit 701

FIG. 8 is a block diagram illustrating an example of the functional configuration of the flow determination unit 701. In FIG. 8, the flow determination unit 701 includes a communication unit 801, an analysis unit 802, an observation unit 803, and a determination unit 804.

The communication unit 801 receives the connection information and the flow information from the virtual switch SWi. Here, the connection information is information indicating a connection relationship between the virtual switch SWi and another virtual switch SWj (j*i, j=1, 2, . . . , n). The connection information includes, for example, SWID of the virtual switch SWi and SWID of the another virtual switch SWj.

In addition, the flow information is communication information of the flow of which segment passes through the virtual switch SWi. The flow information includes, for example, IP addresses, port numbers, and protocol information of virtual machines of the transmitting side and the receiving side. The flow information corresponds to, for example, information for specifying the path through which the segment of the flow passes.

The analysis unit 802 analyzes a connection relationship among the virtual switches on the path based on the connection information and the flow information of each of the virtual switches SW1 to SWn. For example, the analysis unit 802 sets information in each of the fields of Src.SWID, Dst.SWID, S_IP, R_IP, S_PORT, R_PORT, and Protocol within the flow table 500, based on the connection information and the flow information of the virtual switch SWi.

For example, the analysis unit 802 sets the SWID of the virtual switch SWi and the SWID of the another virtual switch SWj, which are specified from the connection information of the virtual switch SWi, in the Src.SWID and the Dst.SWID, respectively. Further, the analysis unit 802 sets the IP addresses, the port numbers, and the protocols of the virtual machines of the transmitting side and the receiving side, which are specified from the flow information of the virtual switch SWi, in each of the fields of S_IP, R_IP, S_PORT, R_PORT, and Protocol. Further, the analysis unit 802 sets a flow ID. Here, the same flow ID is set for flows which are identical to each other in a combination of the IP addresses, the port numbers, and the protocols of the virtual machines of the transmitting side and the receiving side. Thus, new flow management information is registered as a record in the flow table 500. However, at this time, each of the fields of Bytes and AgingCount is “− (Null).”

The observation unit 803 periodically acquires the traffic amount at the flow of which segment passes through the virtual switch SWi, from the virtual switch SWi. For example, the observation unit 803 acquires the traffic amount at the flow of which segment passes through the virtual switch SWi, at a predetermined time T1 interval during a predetermined period P1. In addition, the virtual switch SWi notifies the information processing apparatus 101 of the traffic amount at the flow along with the information that may specify the flow (e.g., the communication information of the flow). Accordingly, the observation unit 803 may specify the flow having the communication amount.

Here, the predetermined period P1 and the predetermined time T1 may be arbitrarily set. The predetermined period P1 is set, for example, to a time period of about one minute. The predetermined time T1 is set to, for example, a time of about 5 seconds. In addition, the acquired traffic amount at the flow is, for example, a cumulative value of the traffic amount at the flow of which segment passes through the virtual switch SWi.

Then, the observation unit 803 sets the acquired traffic amount at the flow in the corresponding Bytes field within the flow table 500. Further, when the traffic amount at the flow does not increase from the previous communication amount, for example, when no data transmission is performed within the predetermined time T1, the observation unit 803 increments the AgingCount.

As an example, it is assumed that a communication amount “4312” of a flow F1 is acquired from the virtual switch SW1. The flow F1 is a flow corresponding to the combination of S_IP “1.10.1.10,” R_IP “1.2.3.5,” S_PORT “35832,” R_PORT “5001,” and Protocol “17.” In this case, the observation unit 803 sets “4312” in the Bytes field of the flow management information 500-1 within the flow table 500. Further, when the traffic amount at the flow which is acquired from the virtual switch SW1 does not increase from the previous communication amount, the observation unit 803 increments the AgingCount. Thus, it is possible to record the communication amount (data transmission amount) and the communication status (data transmission status) of the flow F1 in the virtual switch SW1.

The determination unit 804 determines the specific flow based on a time-series change of the traffic amount at the flow which is periodically acquired from the virtual switch SWi. For example, by referring to the flow table 500, the determination unit 804 may determine a flow having relatively high Bytes and relatively small AgingCount as the specific flow.

As an example, in a case where the flow management information 500-1 and the flow management information 500-2 which are illustrated in FIG. 5 are relatively evaluated, the determination unit 804 determines the flow F2 having the relatively high Bytes and the relatively small AgingCount as the specific flow. In addition, in a case where the flow management information 500-3 and the flow management information 500-4 are relatively evaluated, since the Bytes are the same, the determination unit 804 determines a flow F12 having the relatively small AgingCount as the specific flow.

In addition, for example, by referring to the flow table 500, the determination unit 804 may determine a flow having the Bytes equal to or more than a threshold value α and having the AgingCount equal to or less than a threshold value β, as the specific flow. The threshold values α and β may be arbitrarily set.

As an example, it is assumed that the threshold value α is “100000 [bytes],” and the threshold value β is “2.” In this case, for example, by referring to the flow management information 500-2 of the flow table 500, the determination unit 804 determines the flow F2 having the Bytes equal to or more than the threshold value α and having the AgingCount equal to or less than the threshold value β, as the specific flow.

Further, the determination unit 804 generates the flow information of the determined specific flow. For example, the determination unit 804 generates a flow message FM by making the flow information of the specific flow into a message. The flow message FM includes, for example, the flow ID and the flow information (S_IP, R_IP, S_PORT, R_PORT, and Protocol) of the specific flow.

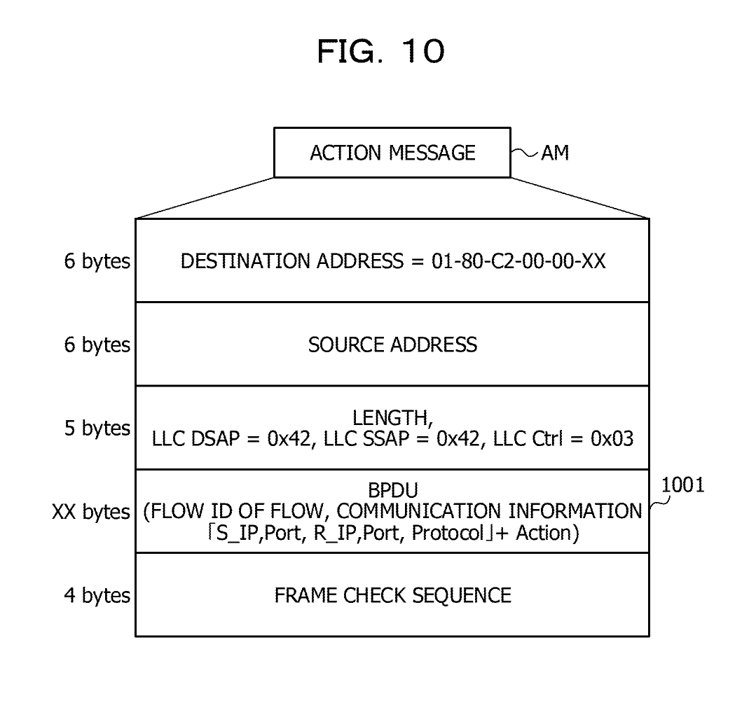

In addition, since an example of a data structure of the flow message FM is similar to an example of a data structure of an action message AM illustrated in FIG. 10 to be described later, illustration and descriptions thereof will be omitted.

The communication unit 801 outputs the generated flow information of the specific flow to the burst monitoring unit 702. For example, the communication unit 801 outputs the flow message FM to the burst monitoring unit 702.

Example of Specific Functional Configuration of Burst Monitoring Unit 702

FIG. 9 is a block diagram illustrating an example of the functional configuration of the burst monitoring unit 702. In FIG. 9, the burst monitoring unit 702 includes a communication unit 901, a setting unit 902, and a recording unit 903.

The communication unit 901 receives the flow information of the specific flow from the flow determination unit 701. For example, the communication unit 901 receives the flow message FM from the flow determination unit 701. The flow message FM includes, for example, the flow ID and the flow information (S_IP, R_IP, S_PORT, R_PORT, and Protocol) of the specific flow.

The setting unit 902 determines the specific flow. For example, by referring to the flow table 500, the setting unit 902 specifies Src.SWID corresponding to the flow ID included in the flow message FM. The Src.SWID is the SWID of the virtual switch SWi through which the segment of the specific flow passes. Next, the setting unit 902 sets the flow ID included in the flow message FM and the specified Src.SWID in the fields of the Flow ID and the SWID, respectively, in the monitoring table 600 illustrated in FIG. 6. Accordingly, the new monitoring information is stored as a record in the monitoring table 600. However, at this time, each of the fields of IN_TIME and OUT_TIME is “− (Null).”

Further, the setting unit 902 sets the virtual switch SWi forming the virtual network to notify the passing information when the segment of the specific flow passes through the virtual switch SWi. For example, the setting unit 902 generates the action message AM based on the flow message FM. Then, the communication unit 901 transmits the action message AM generated by the setting unit 902 to the virtual switch SWi.

The virtual switch SWi which is the transmission destination of the action message AM may be, for example, each of the virtual switches SW1 to SWn forming the virtual network. In addition, the virtual switch SWi which is the transmission destination of the action message AM may be, for example, a virtual switch SWi of the SWID stored in association with the flow ID of the specific flow in the monitoring table 600.

The action message AM is setting information for setting the virtual switch SWi to notify the passage of the segment of the specific flow when the segment of the specific flow passes through the virtual switch SWi. The action message AM includes, for example, the flow ID and the flow information (S_IP, R_IP, S_PORT, R_PORT, and Protocol) of the specific flow included in the flow message FM. Here, the data structure of the action message AM will be described.

FIG. 10 is an explanatory view illustrating an example of the data structure of the action message AM. In FIG. 10, the action message AM includes a bridge protocol data unit (BPDU) 1001. The BPDU 1001 includes the flow ID and the communication information (S_IP, R_IP, S_PORT, R_PORT, and Protocol) of the specific flow, and Action.

The Action regulates an action to notify an event message IM when the segment of the specific flow passes. The event message IM is an example of the passage information indicating the passage of the segment of the specific flow. In addition, as for a Destination Address, a previously reserved MAC address is used. Here, the data structure of the event message IM will be described.

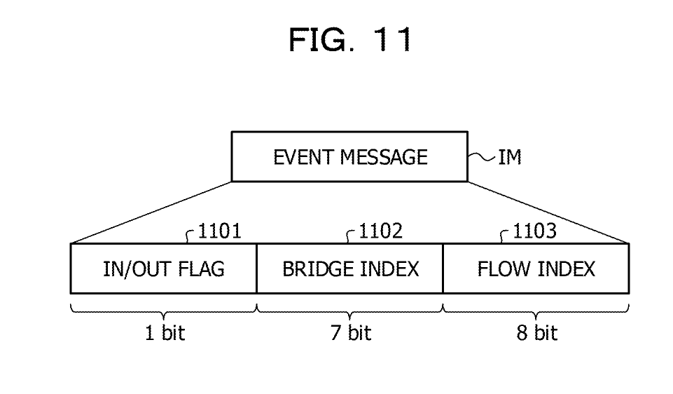

FIG. 11 is an explanatory view illustrating an example of the data structure of the event message IM. In FIG. 11, the event message IM includes an In/Out flag 1101, a bridge index 1102, and a flow index 1103. The In/Out flag 1101 is information indicating whether the segment of the specific flow is input to or output from the virtual switch SWi. Here, when the In/Out flag 1101 is “0,” it indicates that the segment of the specific flow is input to the virtual switch SWi. When the In/Out flag 1101 is “1,” it indicates that the segment of the specific flow is output from the virtual switch SWi.

In addition, the bridge index 1102 is information for uniquely identifying the virtual machine SWi which is the notification source of the event message IM. As for the bridge index 1102, for example, the SWID of the virtual machine SWi as the notification source is set. In addition, the flow index 1103 is information for uniquely identifying the specific flow. As for the flow index 1103, for example, the flow ID of the specific flow is set.

Upon receiving the action message AM from the information processing apparatus 101, the virtual switch SWi refers to the BPDU 1001 of the action message AM (see FIG. 10), and is set to notify the information processing apparatus 101 of the event message IM when the segment of the specific flow passes through the virtual switch SWi. As a result, when the segment of the specific flow is input to the virtual switch SWi, the event message IM including the In/Out flag 1101 of “0” is notified from the virtual switch SWi to the information processing apparatus 101. In addition, when the segment of the specific flow is output from the virtual switch SWi, the event message IM including the In/Out flag 1101 of “1” is notified from the virtual switch SWi to the information processing apparatus 101. In the virtual switch SWi, it is determined whether the segment belongs to the specific flow, from, for example, the IP addresses, the port numbers, the protocols and the like of the virtual machines of the transmitting side and the receiving side of the segment passing through the virtual switch SWi.

In addition, when one flow is determined as the specific flow, in the side of the information processing apparatus 101, the flow of which segment passes through the virtual switch SWi may not be determined. Thus, the event message IM may not include the flow index 1103.

Referring back to the descriptions of FIG. 9, the communication unit 901 receives the passage information indicating the passage of the segment of the specific flow, from the virtual switch SWi. For example, the communication unit 901 receives the event message IM (see FIG. 11) from the virtual switch SWi.

When the passage information is notified from the virtual switch SWi, the recording unit 903 records the notification time of the passage information. For example, when the event message IM is received from the virtual switch SWi, the recording unit 903 generates a time stamp. The time stamp is information indicating the time (e.g., a date and a time up to a microsecond) when the event message IM is received. Next, the recording unit 903 specifies the monitoring information corresponding to the combination of the SWID of the virtual machine SWi and the flow ID of the specific flow which are included in the event message IM, within the monitoring table 600.

Then, when the In/Out flag 1101 included in the event message IM is “0,” the recording unit 903 records the generated time stamp in the IN_TIME of the specified monitoring information. Meanwhile, when the In/Out flag 1101 included in the event message IM is “1,” the recording unit 903 records the generated time stamp in the OUT_TIME of the specified monitoring information.

As an example, it is assumed that the event message IM in which the In/Out flag 1101 is “0,” the bridge index 1102 is “SW1,” and the flow index 1103 is “F1” is notified. In this case, by referring to the monitoring table 600, the recording unit 903 specifies the monitoring information 600-1 corresponding to the combination of “SW1” of the bridge index 1102 and “F1” of the flow index 1103 which are included in the event message IM. Then, since the In/Out flag 1101 is “0,” the recording unit 903 records the time stamp in the IN_TIME of the monitoring information 600-1. Further, a time stamp is sequentially added to each of the fields of IN_TIME and OUT_TIME of the monitoring information.

Example of Specific Functional Configuration of Burst Detection Unit 703

FIG. 12 is a block diagram illustrating an example of the functional configuration of the burst detection unit 703. In FIG. 12, the burst detection unit 703 includes a communication unit 1201, an observation unit 1202, and a determination unit 1203.

The communication unit 1201 receives information indicating a burst detection period P2 and a predetermined time T2. Here, the burst detection period P2 is information for specifying a timing when it is determined whether a burst occurs. The burst detection period P2 is set based on, for example, a time interval of a burst occurring in the actual environment. As for the burst detection period P2, for example, a period of about 200 [ms] to 1 [s] is set.

The predetermined time T2 is a threshold value used for determining whether a burst occurs in the virtual switch SWi. The predetermined time T2 is set to a value at which it may be determined that a burst is highly likely to have occurred in the virtual switch SWi when the time interval at which the passage information (e.g., the event message IM) is notified from the virtual switch SWi is equal to or less than the predetermined time T2. For example, as described above with reference to FIG. 3, in the occurring time of the burst, the interval of the packets is in the unit of several microseconds. Thus, as for the predetermined time T2, for example, a time of about several microseconds is set.

For example, the communication unit 1201 receives a period message DM from an administrator computer of the information processing apparatus 101. The administrator computer is, for example, a PC used by the administrator. The period message DM includes information indicating the burst detection period P2 and the predetermined time T2. Here, the data structure of the period message DM will be described.

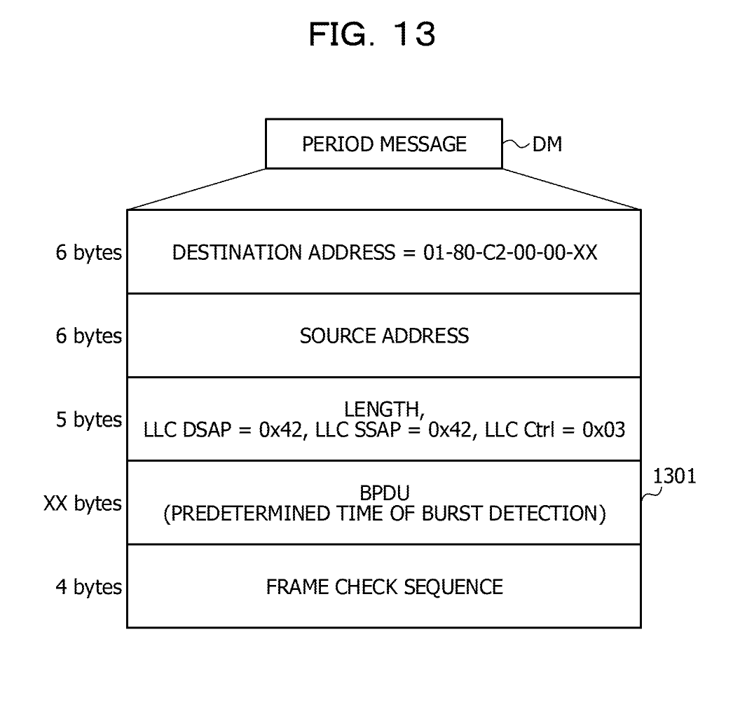

FIG. 13 is an explanatory view illustrating an example of the data structure of the period message DM. In FIG. 13, the period message DM includes a BPDU 1301. The BPDU 1301 includes the information indicating the burst detection period P2 and the predetermined time T2. In addition, as for the Destination Address, a previously reserved MAC address is used.

According to the period message DM, the burst detection period P2 and the predetermined time T2 may be arbitrarily set by, for example, the administrator of the information processing apparatus 101 or the like. In addition, the predetermined period P1 and the predetermined time T1 described above with respect to FIG. 8 may also be set by transmitting a message having the same data structure as or similar data structure to that of the period message DM from the administrator computer to the information processing apparatus 101.

The observation unit 1202 calculates the time interval at which the passage information is notified from the virtual switch SWi. For example, the observation unit 1202 refers to the monitoring table 600 and calculates the time interval at which the event message IM is notified from the virtual switch SWi within the burst detection period P2, each time the burst detection time P2 elapses.

For example, by referring to the monitoring table 600, the observation unit 1202 calculates the time interval of the IN_TIME of each flow in the virtual switch SWi within the burst detection period P2. Accordingly, it is possible to calculate the time interval at which the segment of the specific flow is input to the virtual switch SWi in the burst detection period P2. Further, by referring to the monitoring table 600, the observation unit 1202 calculates the time interval of the OUT_TIME of each flow in the virtual switch SWi within the burst detection period P2. Accordingly, it is possible to calculate the time interval at which the segment of the specific flow is output from the virtual switch SWi in the burst detection period P2.

The determination unit 1203 determines whether a burst is occurring in the virtual switch SWi, based on the calculated time interval at which the passage information is notified from the virtual switch SWi. For example, when the time interval at which the event message IM is notified in the burst detection period P2 is equal to or shorter than the predetermined time T2, the determination unit 1203 may determine that a burst is occurring in the virtual switch SWi.

For example, when an average value of the calculated time intervals of the IN_TIME within the burst detection period P2 is equal to or shorter than the predetermined time T2, the determination unit 1203 determines that a burst is occurring in the virtual switch SWi. In addition, when the average value of the calculated time intervals of the OUT_TIME within the burst detection period P2 is equal to or shorter than the predetermined time T2, the determination unit 1203 determines that a burst is occurring in the virtual switch SWi.

In addition, for example, the average value of the time intervals of the IN_TIME (or the OUT_TIME) within the burst detection period P2 may be obtained by dividing the time interval from the first IN_TIME to the last IN_TIME in the burst detection period P2 by (N−1). The N is the number of the IN_TIMEs within the burst detection period P2, for example, the number of times that the segment of the specific flow is input to the virtual switch SWi within the burst detection period P2.

In addition, when the time interval at which the passage information is notified from the virtual switch SWi is constant, it may be said that a possibility of occurring a burst in the virtual switch SWi is low. Thus, when it is determined that the time interval at which the passage information is notified from the virtual switch SWi is constant, the determination unit 1203 may determine that no burst is occurring in the virtual switch SWi.

For example, when the calculated time intervals of both the IN_TIME and the OUT_TIME within the burst detection period P2 are constant, the determination unit 1203 determines that no burst is occurring in the virtual switch SWi. In addition, it is determined whether the time intervals are constant, based on, for example, statistical values such as a standard deviation or a variance of the time intervals within the burst detection period P2.

As an example, in the monitoring information 600-1, when the time intervals of the IN_TIME and the OUT_TIME within the burst detection period P2 are constant, the determination unit 1203 determines that no burst is occurring in the virtual switch SW1. Meanwhile, when the time interval of the IN_TIME or OUT_TIME within the burst detection period P2 is not constant and an average value of the time intervals of the IN_TIME or OUT_TIME is equal to or shorter than the predetermined time T2, the determination unit 1203 determines that a burst is occurring in the virtual switch SW1. In addition, in the example of FIG. 6, each field of IN_TIME and OUT_TIME represents only one time. However, a time stamp is sequentially added each time the segment of the flow F1 passes through the virtual switch SW1.

In addition, for example, when the number of the segments of the specific flow input to or output from the virtual switch SWi within the burst detection period P2 is equal to or more than a threshold value γ, the determination unit 1203 may determine that a burst is occurring in the virtual switch SWi. The threshold value γ may be arbitrarily set.

In addition, when it is determined that a burst is occurring in the virtual switch SWi, the communication unit 1201 outputs information indicating that a burst is occurring in the virtual switch SWi. Examples of the output form include transmission to an external device by the I/F 403, storage in a storage device such as the memory 402 or the disk 405, display on a display (not illustrated), and printing output to a printer (not illustrated).

For example, the communication unit 1201 may transmit a burst message BM to the administrator computer. The burst message BM is information indicating the virtual switch SWi in which a burst is occurring. Here, an example of the data structure of the burst message BM will be described.

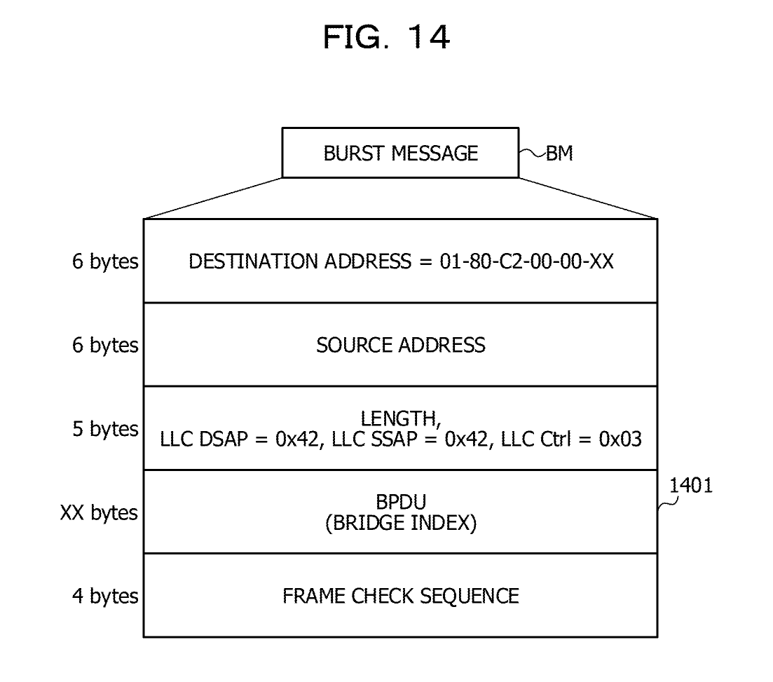

FIG. 14 is an explanatory view illustrating an example of the data structure of the burst message BM. In FIG. 14, the burst message BM includes a BPDU 1401. The BPDU 1401 includes information for uniquely identifying the virtual switch SWi in which a burst is occurring (e.g., SWID). For example, the BPDU 1401 may include a flow ID or communication information of the specific flow observed to detect a burst.

According to the burst message BM, for example, the administrator of the information processing apparatus 101 or the like may grasp the portion within the virtual network where a burst is occurring. As a result, for example, the administrator of the information processing apparatus 101 or the like may take measures such as improving the performance of the CPU 401, lengthening the queue of the virtual switch SWi in which a burst is occurring, or increasing the number of the virtual switches, in order to suppress the occurrence of a burst.

(Example of Detection of Burst)

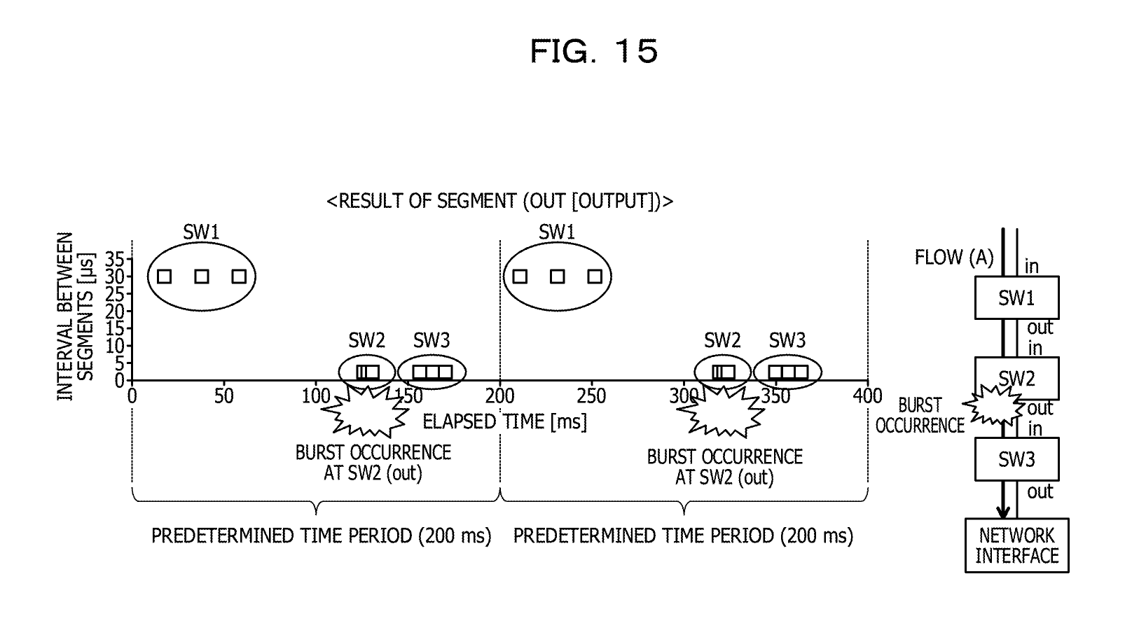

Next, an example of the detection of a burst will be described with reference to FIGS. 15 to 20. Here, it is assumed that the virtual switches SW1 to SW3 form the virtual network (virtual switch SW1→virtual switch SW2→virtual switch SW3). Further, it is assumed that the burst detection period P2 (indicated as “predetermined time interval” in FIGS. 15 to 20) is “200 [ms],” and the predetermined time T2 is a “microsecond (μs) unit.”

FIG. 15 is an explanatory view illustrating an example of a time interval at which the segment of the specific flows passes through each of the virtual switches SW1 to SW3 (a burst at the “out” side of SW2). In FIG. 15, points, each representing a timing at which the segment of the flow (A) as the specific flow is output from each of the virtual switches SW1 to SW3, are plotted (points within each ellipse). The vertical axis indicates the time interval (unit: μs) at which the segment of the specific flow is output from each of the virtual switches SW1 to SW3 (unit: μs). The horizontal axis indicates elapsed time (unit: ms).

In the example of FIG. 15, since the time interval at which the segment of the flow (A) as the specific flow is output from the virtual switch SW2 is continuous in the unit of μs, a burst is occurring. Hereinafter, descriptions will be made on an example of the operation of the information processing apparatus 101 when the burst occurring at the “out” side of the virtual switch SW2 is detected.

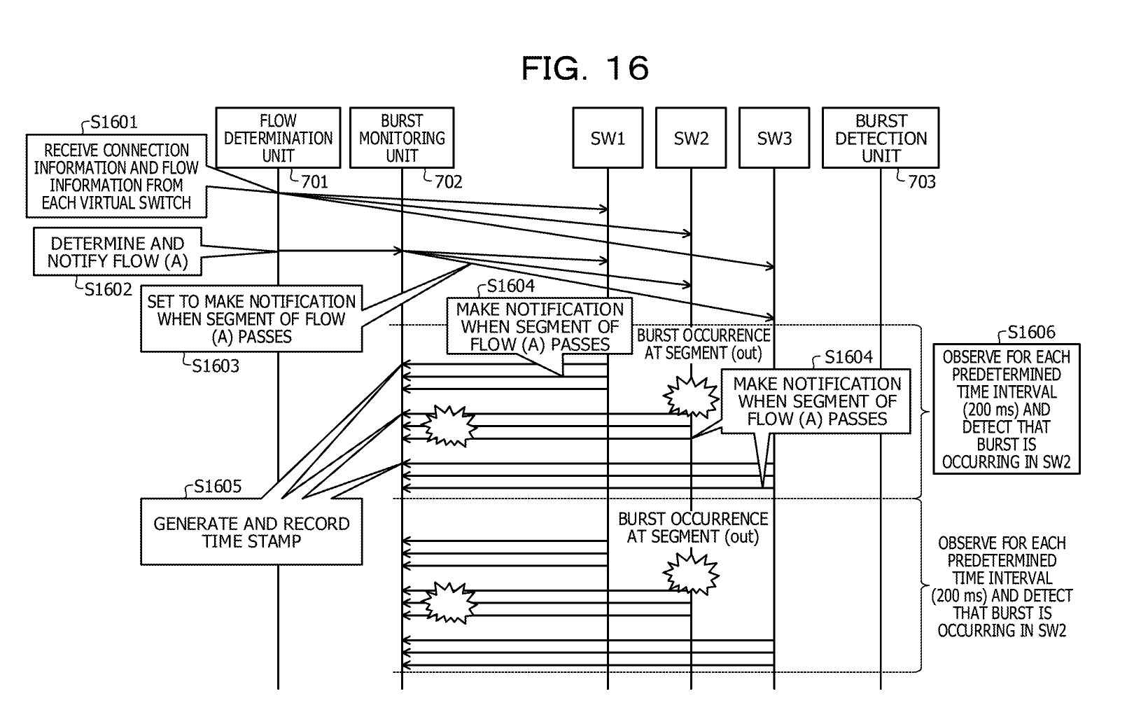

FIG. 16 is an explanatory view illustrating an example of the operation of the information processing apparatus 101 (the burst at the “out” side of SW2). In FIG. 16, the flow determination unit 701 receives the connection information and the flow information from each of the virtual switches SW1 to SW3 (step S1601). Next, the flow determination unit 701 determines the flow (A) as the specific flow, based on the connection information and the flow information of each of the virtual switches SW1 to SW3, and notifies the burst monitoring unit 702 of the flow message FM (step S1602).

Upon receiving the flow message FM, the burst monitoring unit 702 transmits the action message AM to the virtual switches SW1 to SW3 so as to set the virtual switches SW1 to SW3 to notify the burst monitoring unit 702 of the event message IM when the segment of the flow (A) passes (step S1603).

When the segment of the flow (A) passes, each of the virtual switches SW1 to SW3 notifies the burst monitoring unit 702 of the event message IM (step S1604). In the example of FIG. 15, three segments of the flow (A) pass through each of the virtual switches SW1 to SW3 for each burst detection period P2 (200 [ms]), and the event message IM is notified to the burst monitoring unit 702 for each passage.

Upon receiving the event message IM from the virtual switches SW1 to SW3, the burst monitoring unit 702 generates time stamps, discriminates in/out, and record the time stamps in the monitoring table 600 (step S1605). By referring to the monitoring table 600, the burst detection unit 703 determines that a burst is occurring in the virtual switch SW2 since the time interval of OUT_TIME in the virtual switch SW2 within the burst detection period P2 (200 [ms]) is continuous in the unit of μs (step S1606). Thus, it may be detected that a burst is occurring at the “out” side of the virtual switch SW2 for the time interval of the burst detection period P2.

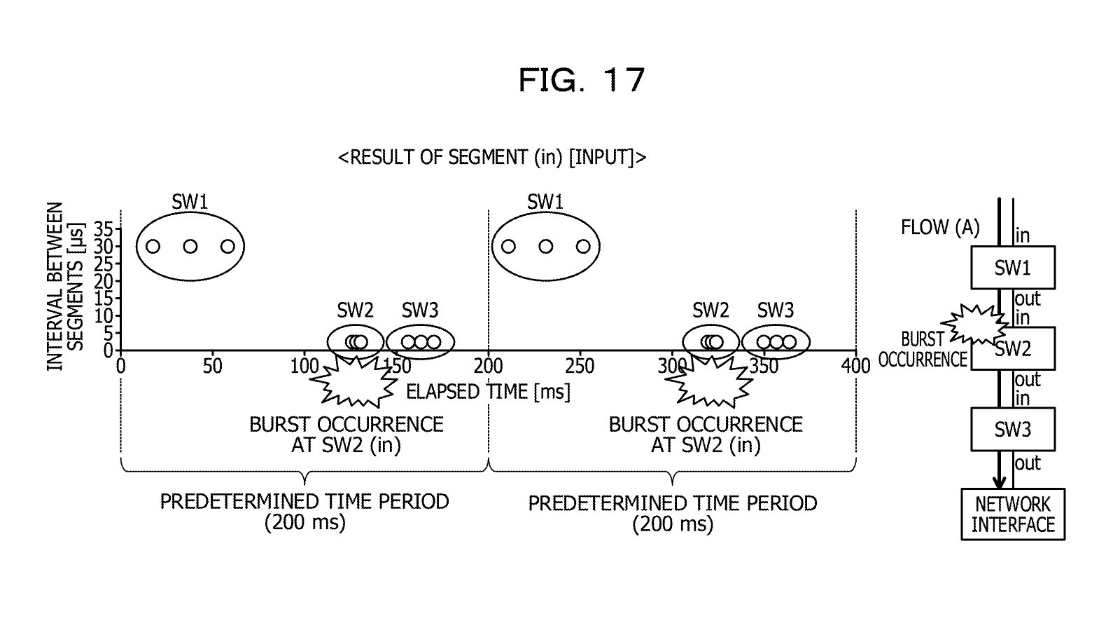

FIG. 17 is an explanatory view illustrating an example of the time interval at which the segment of the specific flow passes through each of the virtual switches SW1 to SW3 (a burst in the “in” side of SW2). In FIG. 17, points representing timings at which the segment of the flow (A) as the specific flow is output from each of the virtual switches SW1 to SW3 are plotted (points within each ellipse).

In the example of FIG. 17, since the time interval at which the segment of the flow (A) as the specific flow is input to the virtual switch SW2 is continuous in the unit of μs, a burst is occurring. Hereinafter, descriptions will be made on an example of the operation of the information processing apparatus 101 when a burst occurring at the “in” side of the virtual switch SW2 is detected.

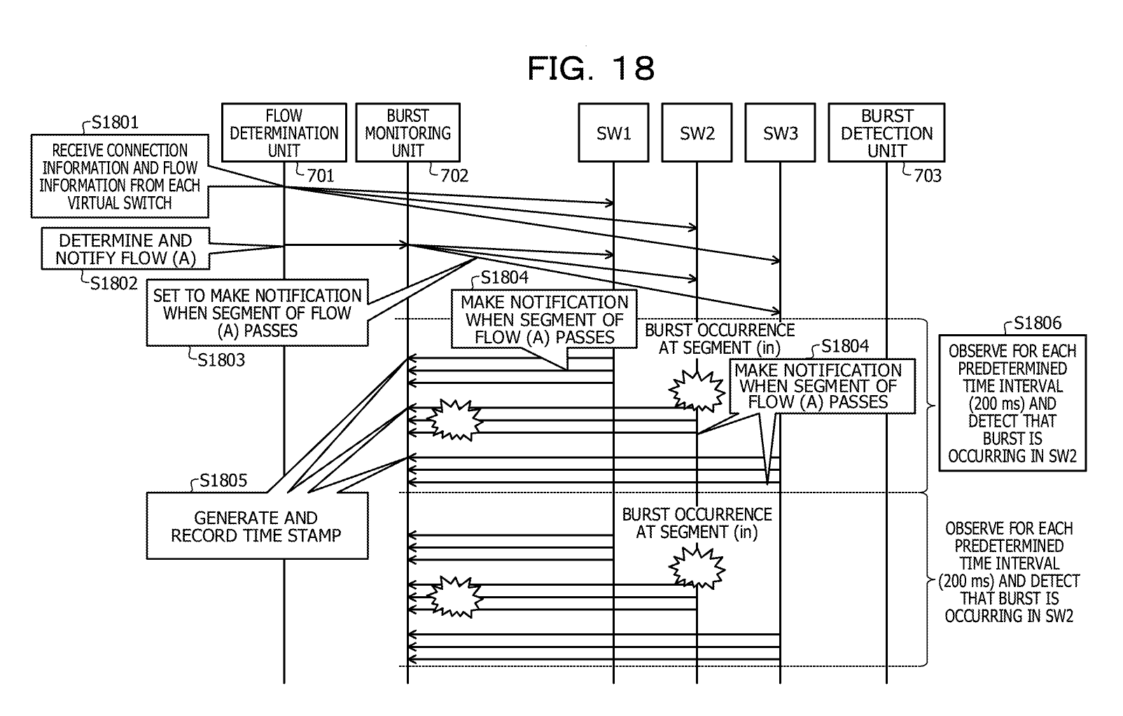

FIG. 18 is an explanatory view illustrating an example of the operation of the information processing apparatus 101 (a burst at the “in” side of SW2). In FIG. 18, the flow determination unit 701 receives the connection information and the flow information from each of the virtual switches SW1 to SW3 (step S1801). Next, the flow determination unit 701 determines the flow (A) as the specific flow based on the connection information and the flow information of each of the virtual switches SW1 to SW3, and notifies the burst monitoring unit 702 of the flow message FM (step S1802).

Upon receiving the flow message FM, the burst monitoring unit 702 transmits the action message AM to the virtual switches SW1 to SW3 so as to set the virtual switches SW1 to SW3 to notify the burst monitoring unit 702 of the event message IM when the segment of the flow (A) passes (Step S1803).

When the segment of the flow (A) passes, each of the virtual switches SW1 to SW3 notifies the burst monitoring unit 702 of the event message IM (step S1804). In the example of FIG. 17, three segments of the flow (A) pass through each of the virtual switches SW1 to SW3 for each burst detection period P2 (200 [ms]), and the event message IM is notified to the burst monitoring unit 702 for each passage.

Upon receiving the event message IM from the virtual switches SW1 to SW3, the burst monitoring unit 702 generates time stamps, discriminates in/out, and record the time stamps in the monitoring table 600 (step S1805). By referring to the monitoring table 600, the burst detection unit 703 determines that a burst is occurring in the virtual switch SW2 since the time interval of IN_TIME in the virtual switch SW2 within the burst detection period P2 (200 [ms]) is continuous in the unit of μs (step S1806). Thus, it may be detected that a burst is occurring at the “in” side of the virtual switch SW2 for the time interval of the burst detection period P2.

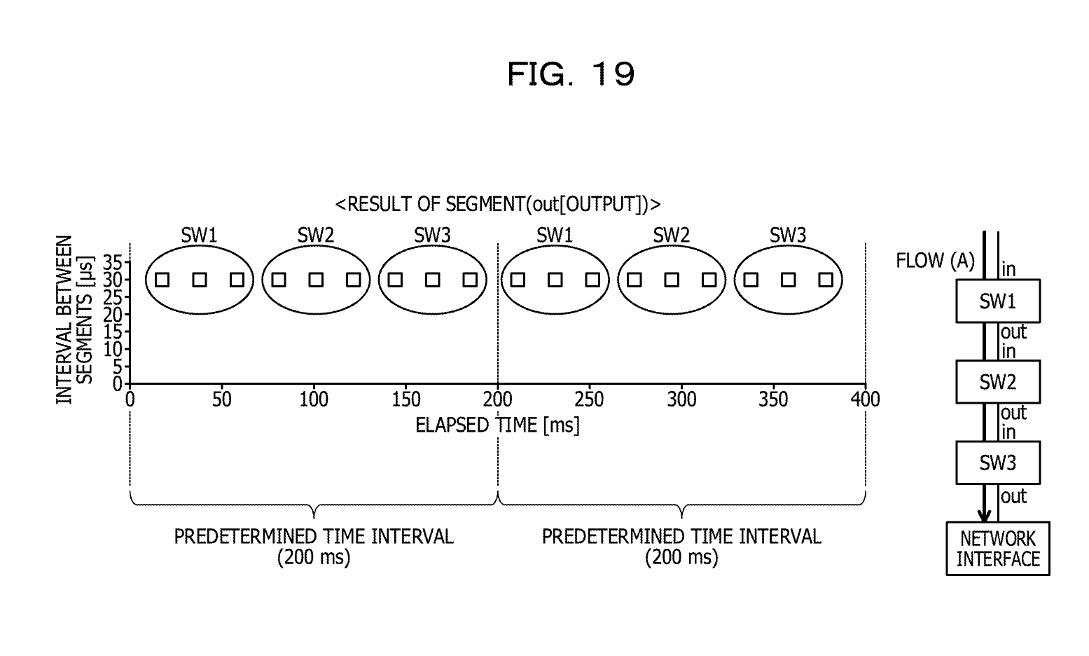

FIG. 19 is an explanatory view illustrating an example of the time interval at which the segment of the specific flow passes through each of the virtual switches SW1 to SW3 (not burst). In FIG. 19, points each representing a timing at which the segment of the flow (A) as the specific flow is output from each of the virtual switches SW1 to SW3 are plotted (points within each ellipse).

In the example of FIG. 19, since the time interval at which the segment of the flow (A) as the specific flow is output from each of the virtual switches SW1 to SW3 is constant and is not continuous in the unit of μs, no burst is occurring. Hereinafter, descriptions will be made on an example of the operation of the information processing apparatus 101 when no burst is occurring at the “out” side of each of the virtual switches SW1 to SW3.

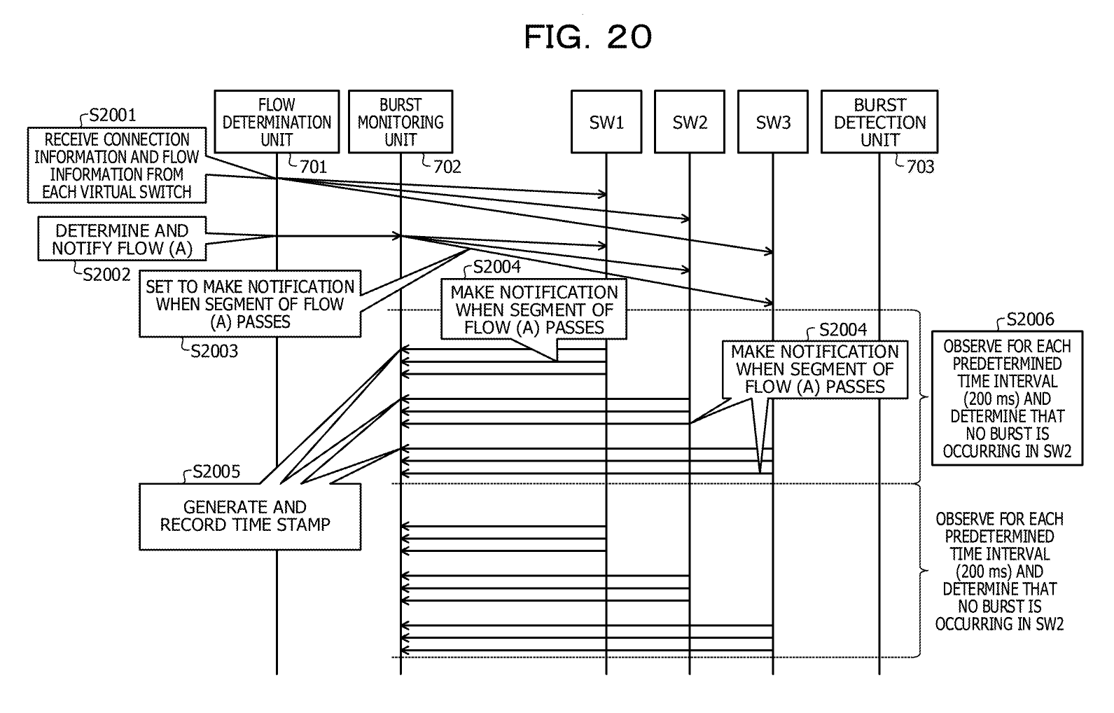

FIG. 20 is an explanatory view illustrating an example of the operation of the information processing apparatus 101 (no burst). In FIG. 20, the flow determination unit 701 receives the connection information and the flow information from each of the virtual switches SW1 to SW3 (step S2001). Next, the flow determination unit 701 determines the flow (A) as the specific flow based on the connection information and the flow information of each of the virtual switches SW1 to SW3, and notifies the burst monitoring unit 702 of the flow message FM (step S2002).

Upon receiving the flow message FM, the burst monitoring unit 702 transmits the action message AM to the virtual switches SW1 to SW3 so as to set the virtual switches SW1 to SW3 to notify the burst monitoring unit 702 of the event message IM when the segment of the flow (A) passes (step S2003).

When the segment of the flow (A) passes, each of the virtual switches SW1 to SW3 notifies the burst monitoring unit 702 of the event message IM (step S2004). In the example of FIG. 19, three segments of the flow (A) pass through each of the virtual switches SW1 to SW3 for each burst detection period P2 (200 [ms]), and the event message IM is notified to the burst monitoring unit 702 for each passage.

Upon receiving the event message IM from the virtual switches SW1 to SW3, the burst monitoring unit 702 generates time stamps, discriminates in/out, and records the time stamps in the monitoring table 600 (step S2005). By referring to the monitoring table 600, the burst detection unit 703 determines that no burst is occurring since the time interval of OUT_TIME in each of the virtual switches SW1 to SW3 within the burst detection period P2 (200 [ms]) is constant and not continuous in the unit of μs (step S2006). Thus, it may be confirmed that no burst is occurring for each burst detection period P2.

(Procedures of Various Processes of Information Processing Apparatus 101)

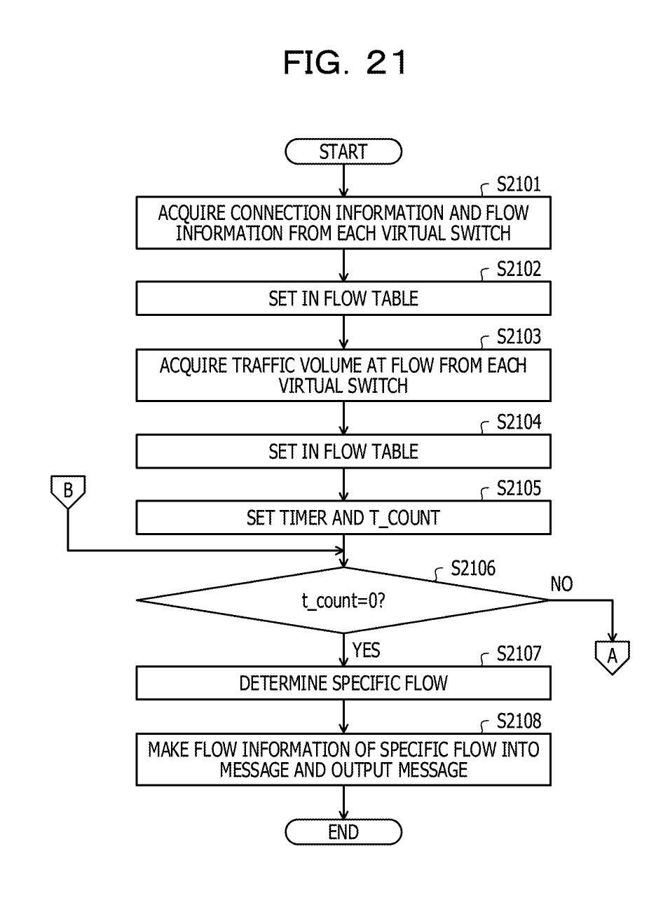

Next, the procedures of the various processes of the information processing apparatus 101 will be described with reference to FIGS. 21 to 24. First, the procedure of the flow determination process by the information processing apparatus 101 will be described.

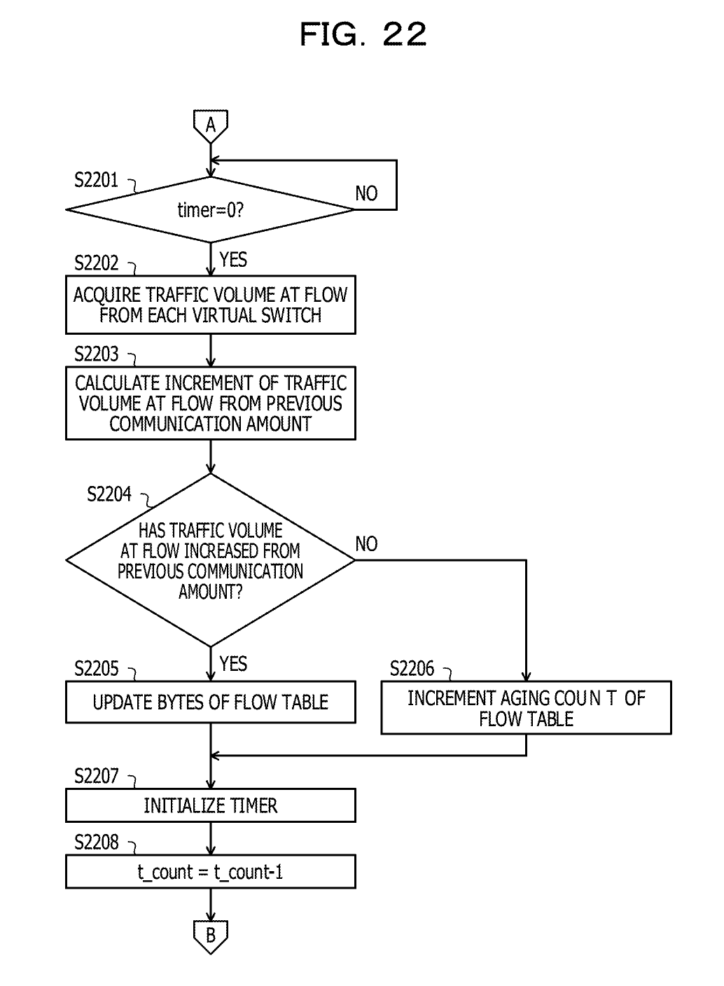

FIGS. 21 and 22 are flowcharts illustrating an example of the procedure of the flow determination process by the information processing apparatus 101. In the flowchart of FIG. 21, first, the flow determination unit 701 of the information processing apparatus 101 acquires the connection information and the flow information from each of the virtual switches SW1 to SWn (step S 2101).

Next, the flow determination unit 701 sets information in each of the fields in the flow table 500 based on the connection information and the flow information acquired from each of the virtual switches SW1 to SWn (step S2102). However, at this time, each of the fields of Bytes and AgingCount is “− (Null).”

Next, the flow determination unit 701 acquires the traffic volume at the flow of which segment passes through each of the virtual switches SW1 to SWn, from each of the virtual switches SW1 to SWn (step S2103). Then, the flow determination unit 701 sets the traffic volume at the flow which has been acquired from each of the virtual switches SW1 to SWn, in the Bytes field of the corresponding flow management information in the flow table 500 (step S2104).

Next, the flow determination unit 701 sets the predetermined time T1, and sets t_count in a timer (step S2105). The timer is a module for measuring time. The t_count corresponds to the number of times of executing the timer. As for the t_count, for example, a value obtained by dividing the predetermined period P1 by the predetermined time T1 is set. For example, when the predetermined period P1 is “1 minute” and the predetermined time T1 is “5 seconds,” “12 (=1 minute/5 seconds)” is set as the t_count.

Next, the flow determination unit 701 determines whether the t_count is “0” (step S2106). Here, when it is determined that the t_count is “0” (step S2106: “Yes”), the flow determination unit 701 refers to the flow table 500 and determines the specific flow (step S2107). Then, the flow determination unit 701 generates the flow message FM by making the flow information of the specific flow into a message, and outputs the flow message FM to the burst monitoring unit 702 (step S2108). Then, the series of processes according to the present flowchart are ended.

In addition, when it is determined at step S2106 that the t_count is not “0” (step S2106: “No”), the flow determination unit 701 proceeds to step S2201 illustrated in FIG. 22.

In the flowchart of FIG. 22, first, the flow determination unit 701 determines whether the timer reaches “0” (step S2201). Here, the flow determination unit 701 waits until the timer reaches “0” (step S2201: “No”). Then, when it is determined that the timer reaches “0” (step S2201: “Yes”), the flow determination unit 701 acquires the traffic amount at the flow of which segment passes through each of the virtual switches SW1 to SWn, from each of the virtual switches SW1 to SWn (step S2202).

Next, by referring to the flow table 500, the flow determination unit 701 calculates an increment of the traffic amount at the flow from a previous communication amount (step S2203). Then, based on the calculated increment, the flow determination unit 701 determines whether the traffic amount at the flow has increased from the previous communication amount (step S2204).

Here, when it is determined that the traffic amount at the flow has increased from the previous communication amount (step S2204: “Yes”), the flow determination unit 701 updates the Bytes field of the corresponding flow management information in the flow table 500 to the acquired traffic amount at the flow (step S2205), and the process proceeds to step S2207.

Meanwhile, when it is determined that the traffic amount at the flow has not increased from the previous communication amount (step S2204: “No”), the AgingCount of the corresponding flow management information in the flow table 500 is incremented (step S2206). In addition, the processes of steps S2203 to S2206 are performed for the flow of each record in the flow table 500.

Next, the flow determination unit 701 initializes the timer (step S2207). Then, the flow determination unit 701 decrements the t_count (step S2208) and returns to step S2106 illustrated in FIG. 21. Further, in step S2204, the flow determination unit 701 may determine that the traffic amount at the flow has not increased from the previous communication amount, when the traffic amount at the flow has not increased by a predetermined value x or more from the previous communication amount. The predetermined value x may be arbitrarily set.

Accordingly, the flow which is highly likely to cause a burst due to a higher communication amount or communication frequency than other flows may be determined as the specific flow when the flow rate of the flow in each of the switches SW1 to SWn is observed during the predetermined period P1.

Next, a procedure of the burst monitoring process by the information processing apparatus 101 will be described.

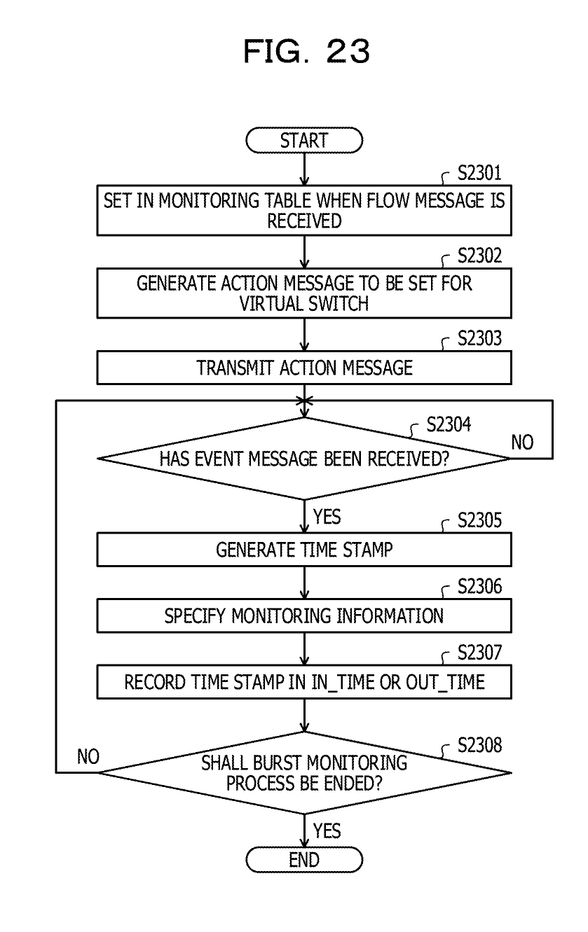

FIG. 23 is a flowchart illustrating an example of the procedure of the burst monitoring process by the information processing apparatus 101. In the flowchart of FIG. 23, first, when receiving the flow message FM from the flow determination unit 701, the burst monitoring unit 702 of the information processing apparatus 101 sets the flow ID included in the flow message FM and Src.SWID associated with the flow ID, in the fields of Flow ID and SWID in the monitoring table 600, respectively (step S2301). However, at this time, each of the fields of IN_TIME and OUT_TIME is “− (Null).”

Next, the burst monitoring unit 702 generates the action message AM to be set for each virtual switch SWi, based on the flow message FM (step S2302). Then, the burst monitoring unit 702 transmits the generated action message AM to each virtual switch SWi (step S2303). As a result, the virtual switch SWi is set to notify the event message IM to the burst monitoring unit 702 of the information processing apparatus 101 when the segment of the specific flow passes.

Next, the burst monitoring unit 702 determiners whether the event message IM has been received from the virtual switch SWi (step S2304). Here, the burst monitoring unit 702 waits until the event message IM is received (step S2304: “No”). Then, when it is determined that the event message IM has been received (step S2304: “Yes”), the burst monitoring unit 702 generates a time stamp (step S2305).

Next, the burst monitoring unit 702 specifies the monitoring information corresponding to the combination of the SWID of the virtual machine SWi and the flow ID of the specific flow which are included in the event message IM, within the monitoring table 600 (step S2306). Then, the burst monitoring unit 702 refers to the In/Out flag 1101 included in the event message IM and records the generated time stamps in the IN_TIME or OUT_TIME of the specified monitoring information (step S2307).

Next, the burst monitoring unit 702 determines whether or not to end the burst monitoring process (step S2308). The timing for ending the burst monitoring process is designated by, for example, the administrator of the information processing apparatus 101. Here, when it is determined not to end the burst monitoring process (step S2308: “No”), the burst monitoring unit 702 returns to step S2304.

Meanwhile, when it is determined to end the burst monitoring process (step S2308: “Yes”), the burst monitoring unit 702 ends the series of processes according to the present flowchart. Accordingly, the time when the segment of the specific flow passes though (are input to or output from) the virtual switch SWi may be recorded in the monitoring table 600.

Next, the procedure of the burst detection process by the information processing apparatus 101 will be described.

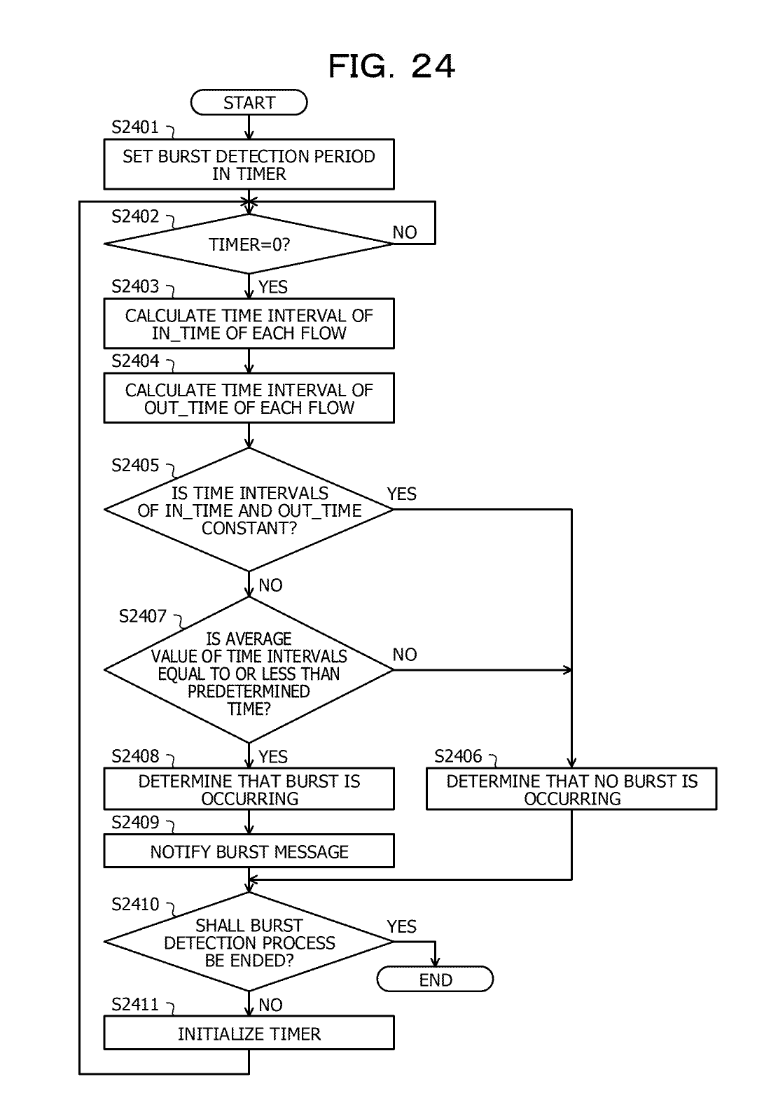

FIG. 24 is a flowchart illustrating an example of the procedure of the burst detection process by the information processing apparatus 101. In the flowchart of FIG. 24, first, the burst detection unit 703 of the information processing apparatus 101 sets the burst detection period P2 in the timer (step S2401). Next, the burst detection unit 703 determines whether the timer reaches “0” (step S2402).

Here, the burst detection unit 703 waits until the timer reaches “0” (step S2402: “No”). Then, when it is determined that the timer reaches “0” (step S2402: “Yes”), the burst detection unit 703 refers to the monitoring table 600 and calculates the time interval of IN_TIME of each flow in the virtual switch SWi within the burst detection period P2 (step S2403).

Next, by referring to the monitoring table 600, the burst detection unit 703 calculates the time interval of OUT_TIME of each flow in the virtual switch SWi within the burst detection period P2 (step S2404). Then, the burst detection unit 703 determines whether the time intervals of IN_TIME and OUT_TIME are constant, based on the calculated time intervals of IN_TIME and OUT_TIME of each flow (step S2405).

Here, when it is determined that the time intervals of IN_TIME and OUT_TIME are constant (step S2405: “Yes”), the burst detection unit 703 determines that no burst is occurring in the virtual switch SWi (step S2406), and the process proceeds to step S2410.

Meanwhile when it is determined that the time intervals of at least one of IN_TIME and OUT_TIME are not constant (step S2405: “No”), the burst detection unit 703 determines whether the average value of the time intervals of IN_TIME and OUT_TIME is equal to or less than the predetermined time T2 (step S2407). Here, when it is determined that the average values of the time intervals of IN_TIME and OUT_TIME are more than the predetermined time T2 (step S2407: “No”), the burst detection unit 703 proceeds to step S2406.

Meanwhile, when it is determined that the average value of the time intervals of at least one of IN_TIME and OUT_TIME is equal to or less than the predetermined time T2 (step S2407: “Yes”), the burst detection unit 703 determines that a burst is occurring in the virtual switch SWi (step S2408). Then, the burst detection unit 703 notifies the administrator computer of the burst message BM indicating that a burst is occurring in the virtual switch SWi (step S2409).

Next, the burst detection unit 703 determines whether or not to end the burst detection process (step S2410). The timing for ending the burst detection process is designated by the administrator of the information processing apparatus 101. Here, when it is determined not to end the burst detection process (step S2410: “No”), the burst detection unit 703 initializes the timer (step S2411), and the process returns to step S2402.

Meanwhile, when it is determined to end the burst detection process (step S2410: “Yes”), the burst detection unit 703 ends the series of process according to the present flowchart. In this way, it may be determined whether a burst is occurring in each virtual switch SWi at the time interval of the burst detection period P2. Further, when it is determined that a burst is occurring in the virtual switch SWi, the occurrence of the burst may be notified to the administrator of the information processing apparatus 101.

As described above, in the information processing apparatus 101 according to the embodiment, the virtual switch SWi forming the virtual network may be set to notify the passage information (e.g., the event message IM) when the segment of the specific flow passes through the virtual switch SWi. Further, according to the information processing apparatus 101, when the passage information is notified from the virtual switch SWi, a time stamp indicating the notification time of the passage information may be generated and recorded in the monitoring table 600. Further, according to the information processing apparatus 101, it may be determined whether a burst is occurring in the virtual switch SWi, based on the time (time stamp) recorded in the monitoring table 600.

As a result, the process load caused by the burst detection may be suppressed, and the burst detection in real time may be implemented. For example, by using the segment of the specific flow, the process load caused by the burst detection may be reduced, as compared with a case where all packets or segments of all flows are used. Further, each virtual switch SWi does not need to perform a process of generating the time stamp when the segment of the specific flow passes, or incorporating the time stamp into the header. Thus, in each virtual switch SWi, many CPU resources may be suppressed from being consumed for the burst detection. Further, since incorporating the time stamp into the header of a packet is not performed, dividing packets or resetting the MTU may not be performed even when the number of the virtual switches increases.

In addition, according to the information processing apparatus 101, when the time interval at which the passage information is notified from the virtual switch SWi in the burst detection period P2 is equal to or less than the predetermined time T2 (e.g., several microseconds), it may be determined that a burst is occurring in the virtual switch SWi. Thus, it may be determined that a burst is occurring when the same behavior as or similar behavior to that when a burst occurs in the actual environment is exhibited. As a result, the accuracy of the burst detection may be improved.

In addition, according to the information processing apparatus 101, when the time interval at which the passage information is notified from the virtual switch SWi in the burst detection period P2 is constant, it may be determined that no burst is occurring in the virtual switch SWi. Accordingly, when the communication frequency in the virtual switch SWi is constant and the possibility of the occurrence of a burst is low, it may be determined that no burst is occurring in the virtual switch SWi.

In addition, according to the information processing apparatus 101, it may be determined whether a burst is occurring in the virtual switch SWi, for each burst detection period P2 (e.g., 200 milliseconds). Thus, the burst detection may be repeatedly performed in consideration of a time interval of a burst occurring in the actual environment.

In addition, according to the information processing apparatus 101, the specific flow may be determined by periodically acquiring the traffic amount at the flow of which segment passes through the virtual switch SWi, from each virtual switch SWi, and referring to the time-series change of the traffic amount at the flow acquired from each virtual switch SWi. Thus, by observing the flow rate of the flow in each switch SWi, the flow which is highly likely to cause a burst due to a higher communication amount or communication frequency than other flows may be determined as the specific flow.

In addition, according to the information processing apparatus 101, when it is determined that a burst is occurring in the virtual switch SWi, the information indicating that a burst is occurring in the virtual switch SWi (e.g., the burst message BM) may be output. As a result, when it is determined that a burst is occurring in the virtual switch SWi, the occurrence of the burst may be notified to, for example, the administrator of the information processing apparatus 101 or the like.

In addition, according to the information processing apparatus 101, when the time interval at which the segment of the specific flow is input to or output from the virtual switch SWi is equal to or less than the predetermined time T2, it may be determined that a burst is occurring in the virtual switch SWi. As a result, it is possible to detect a burst occurring at each of the “in” side and the “out” side of the virtual switch SWi.

From the foregoing points, according to the information processing apparatus 101, the burst detection in real time may be implemented while suppressing the CPU load. As a result, when a burst occurs in the virtual network, for example, the administrator of the information processing apparatus 101 or the like may specify the occurrence of a burst and the occurring place of the burst, and thus, promptly respond to the burst.

In addition, the burst detection method described in the present embodiment may be implemented by causing a computer such as a personal computer or a workstation to execute a previously prepared program. The burst detection program is stored in a computer-readable recording medium such as a hard disk, a flexible disk, a compact disc (CD)-ROM, a magneto-optical (MO) disk, a digital versatile disk (DVD), a universal serial bus (USB) memory, and is executed by being read out by the computer from the recording medium. In addition, the present burst detection program may be distributed via a network such as the Internet.

All examples and conditional language recited herein are intended for pedagogical purposes to aid the reader in understanding the disclosure and the concepts contributed by the inventor to furthering the art, and are to be construed as being without limitation to such specifically recited examples and conditions, nor does the organization of such examples in the specification relate to a showing of the superiority and inferiority of the disclosure. Although the embodiment(s) of the present disclosure has (have) been described in detail, it should be understood that the various changes, substitutions, and alterations could be made hereto without departing from the spirit and scope of the disclosure.

What is claimed is:

1. A non-transitory computer-readable recording medium having stored therein a program for causing a computer to execute a burst detection process, the burst detection process comprising:
setting a virtual switch to notify passage information indicating a passage of a segment of a specific flow when the segment of the specific flow passes through the virtual switch;
recording notification time of the passage information in a storage when the passage information is notified from the virtual switch; and
determining whether a burst occurs in the virtual switch, based on the notification time of the passage information recorded in the storage.

2. The non-transitory computer-readable recording medium according to claim 1, wherein in the determining, it is determined that the burst occurs in the virtual switch, when a time interval at which the passage information is notified in a predetermined period is equal to or shorter than a predetermined time.

3. The non-transitory computer-readable recording medium according to claim 1, wherein in the determining, it is determined that no burst occurs in the virtual switch, when the time interval at which the passage information is notified in a predetermined period is constant.

4. The non-transitory computer-readable recording medium according to claim 1, wherein the burst detection process further comprising:
acquiring, from each of virtual switches which include the virtual switch and form a virtual network, a traffic amount at a flow of which segment passes through each of the virtual switches; and
determining the specific flow based on a time-series change of the traffic amount at the flow acquired from each of the virtual switches.

5. The non-transitory computer-readable recording medium according to claim 1, wherein the burst detection process further comprising:
outputting information indicating that the burst occurs in the virtual switch, when it is determined that the burst occurs in the virtual switch.

6. The non-transitory computer-readable recording medium according to claim 2, wherein the passage information includes information indicating whether the segment of the specific flow is input to or output from the virtual switch, and in the determining, it is determined that the burst occurs in the virtual switch, when a time interval at which the segment of the specific flow is input to or output from the virtual switch is equal to or less than the predetermined time.

7. The non-transitory computer-readable recording medium according to claim 2, wherein in the determining, it is determined whether the burst is occurring in the virtual switch, for each time of the predetermined period.

8. A burst detection method comprising:
setting, by a computer, a virtual switch to notify passage information indicating a passage of a segment of a specific flow when the segment of the specific flow passes through the virtual switch;
recording notification time of the passage information in a storage when the passage information is notified from the virtual switch; and
determining whether a burst occurs in the virtual switch, based on the notification time of the passage information recorded in the storage.

9. The burst detection method according to claim 8, wherein in the determining, it is determined that the burst occurs in the virtual switch, when a time interval at which the passage information is notified in a predetermined period is equal to or shorter than a predetermined time.

10. The burst detection method according to claim 8, wherein in the determining, it is determined that no burst occurs in the virtual switch, when the time interval at which the passage information is notified in a predetermined period is constant.

11. The burst detection method according to claim 8, further comprising:
acquiring, from each of virtual switches which include the virtual switch and form a virtual network, a traffic amount at a flow of which segment passes through each of the virtual switches; and
determining the specific flow based on a time-series change of the traffic amount at the flow acquired from each of the virtual switches.

12. The burst detection method according to claim 8, further comprising:
outputting information indicating that the burst occurs in the virtual switch, when it is determined that the burst occurs in the virtual switch.

13. The burst detection method according to claim 9, wherein the passage information includes information indicating whether the segment of the specific flow is input to or output from the virtual switch, and in the determining, it is determined that the burst occurs in the virtual switch, when a time interval at which the segment of the specific flow is input to or output from the virtual switch is equal to or less than the predetermined time.

14. An information processing apparatus comprising:
a memory; and
a controller including a processor in communication with the memory and configured to:
set a virtual switch to notify passage information indicating a passage of a segment of a specific flow when the segment of the specific flow passes through the virtual switch;
record notification time of the passage information in a storage when the passage information is notified from the virtual switch; and
determine whether a burst occurs in the virtual switch, based on the notification time of the passage information recorded in the storage.

15. The information processing apparatus according to claim 14, wherein in the determining, it is determined that the burst occurs in the virtual switch, when a time interval at which the passage information is notified in a predetermined period is equal to or shorter than a predetermined time.

16. The information processing apparatus according to claim 14, wherein in the determining, it is determined that no burst occurs in the virtual switch, when the time interval at which the passage information is notified in a predetermined period is constant.

17. The information processing apparatus according to claim 14, wherein the controller:
acquires, from each of virtual switches which include the virtual switch and form a virtual network, a traffic amount at a flow of which segment passes through each of the virtual switches; and
determines the specific flow based on a time-series change of the traffic amount at the flow acquired from each of the virtual switches.

18. The information processing apparatus according to claim 14, wherein the controller:
outputs information indicating that the burst occurs in the virtual switch, when it is determined that the burst occurs in the virtual switch.

19. The information processing apparatus according to claim 15, wherein the passage information includes information indicating whether the segment of the specific flow is input to or output from the virtual switch, and in the determining, it is determined that the burst occurs in the virtual switch, when a time interval at which the segment of the specific flow is input to or output from the virtual switch is equal to or less than the predetermined time.
